(19) United States
(12) Patent Application Publication
(10) Pub. No.: US 2019/0287002 A1
(43) Pub. Date: Sep. 19, 2019

(54) METHODS AND SYSTEMS FOR TRANSFORMING COMPUTING ANALYTICS FRAMEWORKS INTO CROSS-PLATFORM REAL-TIME DECISION-MAKING SYSTEMS THAT OPTIMIZE CONFIGURABLE GOAL METRICS

(71) Applicant: SCALED INFERENCE, INC., Palo Alto, CA (US)

(72) Inventors: Ajay BHOJ, San Mateo, CA (US); Joseph ROBINSON, San Mateo, CA (US); Huan-Kai PENG, Redwood City, CA (US); Olcan SERCINOGLU, Palo Alto, CA (US)

(21) Appl. No.: 16/183,260

(22) Filed: Nov. 7, 2018

Related U.S. Application Data
(60) Provisional application No. 62/748,225, filed on Oct. 19, 2018.
(60) Provisional application No. 62/643,028, filed on Mar. 14, 2018.

(51) Int. Cl. G06N 5/04; G06N 5/02; H04L 29/08; H04L 12/26; H04L 12/24; G06N 20/00; G06F 11/34

(52) U.S. Cl. CPC G06N 5/04; G06N 5/02; H04L 67/125; H04L 67/025; H04L 67/34; G06F 2201/86; H04L 43/045; H04L 41/16; G06N 20/00; G06F 11/3419; G06F 2201/865; H04L 43/067

(57) ABSTRACT

Systems described herein provide structures and functionality for transforming passive analytics systems into systems that can actively modify software behavior based on analytic data to improve software performance relative to configurable goal metrics. An example method generally includes generating a decision-making policy representing logic learned by a machine-learning model from time-series data collected for sessions of a software application; deploying the decision-making policy; receiving a decision-making request originating from the software application including a consumer identifier and a decision-point type; retrieving time-series data in a session associated with the consumer identifier; selecting actions for the software application to perform by comparing the time-series data and the event type to the decision-making policy; sending an indication of the selected actions in response to the decision-making request; and updating data in the session associated with the consumer identifier to reflect the decision-point event and the one or more selected actions.

### CROSS-REFERENCE TO RELATED APPLICATIONS

This application claims benefit to U.S. Provisional Patent Application Ser. No. 62/643,028, entitled “Methodologies to Transform Data Analytics Systems Into Cross-Platform Real-Time Decision-Making Systems That Optimize For Configurable Goal Metrics,” filed Mar. 14, 2018, and U.S. Provisional Patent Application Ser. No. 62/748,225, entitled “Methodologies to Transform Data Analytics Systems Into Cross-Platform Real-Time Decision-Making Systems That Optimize For Configurable Goal Metrics,” both of which are assigned to the assignee hereof, the contents of which are both hereby incorporated by reference in their entirety

### BACKGROUND

### Field

Embodiments disclosed herein generally relate to systems for extending software analytics frameworks. Specifically, embodiments disclosed herein provide structures and functionality for transforming passive analytics systems into decision-making systems (and/or recommendation systems) that can actively modify software behavior based on analytic data to improve software performance relative to configurable goal metrics.

### Description of the Related Art

Network-connected software applications (e.g., native applications, web applications, and hybrid applications) and websites are a valuable resource for many organizations. Such applications and websites can suit a variety of purposes. For example, some mobile applications, such as games, are designed to entertain users. Other mobile applications, such as word processors, are designed for business purposes. Some websites are used for disseminating information about organizations or the causes those organizations promote. Other websites are designed to facilitate communication and collaboration between website patrons, while other websites are used to advertise products or services or to facilitate secure transactions between merchants and customers. Regardless, organizations that create or provide applications and websites typically do so with some purpose in mind—some target outcome the application or website is meant to achieve consistently over time.

Most organizations understand that not all applications and websites are effective for achieving their intended purposes. For example, some applications fail to attract and retain users due to confusing interfaces, excessive latency, bugs, or compatibility problems. Some websites fail to attract and retain site visitors due to outdated content, poor presentation, compatibility problems with certain types of browsers or devices, poor security protocols, and other issues. In order to ensure that applications or websites continue to serve their intended purposes effectively, organizations may use tools such as Google™ Analytics, Springmetrics, Crazy Egg, Kissmetrics, Optimizely, Woopra, and the like to monitor how users respond to different pages within applications or websites so that pages that are not achieving an intended purpose to a desired degree can be identified and replaced.

Sometimes, organizations perform A/B testing by deploying two different versions of a page for display to users and monitoring user responses to both versions. If one version outperforms the other during the testing phase, the organization typically adopts the version that performs better after the testing phase ends.

### SUMMARY

One embodiment of the present disclosure includes a system comprising: one or more processors and memory storing one or more instructions that, when executed on the one or more processors, cause the system to: receive, from a policy generator, a decision-making policy that specifies one or more actions for a software application to perform when the software application detects decision-point events, wherein the policy maps decision-point events of a same decision-point event type to different actions based on time-series data in sessions associated with consumers that interact with the software application; receive a decision-making request originating from the software application, wherein the decision-making request includes a consumer identifier and indicates the decision-point event type; retrieve, from a data repository, time-series data in a session associated with the consumer identifier; select one or more of the different actions for the software application to perform by comparing the time-series data and the event type to the decision-making policy; send an indication of the one or more selected actions in response to the decision-making request; and update the time-series data in the session associated with the consumer identifier in the data repository to reflect the decision-point event and the one or more selected actions.

Another embodiment includes a system comprising: one or more processors and memory storing one or more instructions that, when executed on the one or more processors, cause the system to: receive, at a computing device, client-side code associated with a software application; detect a decision-point event based on input received at the computing device from a consumer interacting with the software application; identify time-series data stored in a session container associated with the consumer; select one or more different actions for the software application to perform in response to the detection of the decision-point event by comparing the time-series data and a type of the decision-point event to a decision-making policy included in the client-side code; and perform the one or more selected actions at the computing device.

Another embodiment includes a system comprising: one or more processors and memory storing one or more instructions that, when executed on the one or more processors, cause the system to: receive, via a computing network, time-series data collected by a remotely executed software application for a plurality of sessions, wherein each session is associated with a respective consumer; store the time-series data in a persistent data repository; receive a goal definition via an interface component, wherein the goal definition specifies how to calculate a goal score based on at least one metric that is calculable based on the time-series data; for each of the sessions, determining a corresponding value for the at least one metric for the session; based on the time-series data and the values for the sessions, training a machine-learning model to determine, based on events that precede a decision-point event in a session, one or more actions for the remotely executed software application to perform in response to the decision-point event to increase a probability that a goal score for the session will satisfy a hazard condition; generating a decision-making policy that represents logic learned by machine-learning model during the training; and deploying the policy to a location in the computing network where decision-making requests originating from the software application are received.

Another embodiment includes a system comprising: one or more processors and memory storing one or more instructions that, when executed on the one or more processors, cause the system to: receive a plurality of sessions, wherein each session is associated with a consumer, has a starting time, and includes time-series data characterizing interactions between the consumer and a software application executed at one or more remote computing devices; receive a goal definition via an interface component, wherein the goal definition specifies how to calculate a goal score based on at least one metric that is calculable based on the time-series data; group the sessions into bins, wherein each bin corresponds to a time interval and includes sessions that have starting times within the time interval; for each session: calculate a current value of the first metric for the session using the time-series data included in the session, wherein at least a portion of the time-series data used to calculate the current value of the first metric describes events that occurred outside of a time interval corresponding to a bin into which the session is grouped, and determine a current goal score for the session based on the current value for the first metric and the goal definition; for each bin, calculate a current average goal score for the bin based on the current values goal scores for the sessions that are grouped into the bin; and render a graphical plot of the current average goal scores for the bins against time as partitioned by the bins for display via the interface component.

Another embodiment includes a system comprising: one or more processors and memory storing one or more instructions that, when executed on the one or more processors, cause the system to: receive, at a computing device, a speculative decision-making request from a software application, wherein the speculative decision-making request includes a consumer identifier; generate, in response to the decision-making request, a plurality of actions associated with a plurality of a decision-point events to be detected in consumer interaction with the software application; transmit, to the computing device, content requested by a consumer interacting with the software application, the plurality of decision-point events and actions associated with each of the plurality of decision-point events; detect a decision-point event of the plurality of decision-point events based on input received at the computing device from a consumer interacting with the software application; perform the action associated with the detected decision-point event at the computing device; receive, from the computing device, information identifying the detected decision-point event and the action associated with the detected decision-point event performed at the computing device; and save, to a session container associated with the consumer, time-series data associated with the identified decision-point event, the time-series data comprising the decision-point event and a timestamp associated with the detected decision-point event.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure. The scope of the disclosure may admit to other embodiments.

FIG. 1a illustrates a first example computing environment in which systems of the present disclosure may operate, according to one embodiment.

FIG. 1b illustrates a second example computing environment in which systems of the present disclosure may operate, according to one embodiment.

FIG. 1c illustrates a third example computing environment in which systems of the present disclosure may operate, according to one embodiment.

FIG. 2 illustrates a fourth example computing environment in which systems of the present disclosure may operate, according to one embodiment.

FIG. 3 illustrates an example signal diagram for communications between a back-end system, a decision-making agent, a server-side application, and an endpoint device, according to one embodiment.

FIG. 4 illustrates an example signal diagram for communications between a back-end system, a decision-making agent, and a client-side application, according to one embodiment.

FIG. 5 illustrates an example interface through which an administrator (i.e., a customer using the interface) may provide a metric definition and an optimization direction for a metric, according to one embodiment.

FIG. 6 illustrates an example interface through which an administrator may specify hazard conditions and target conditions for metrics that are parameters of a goal definition, according to one embodiment.

FIG. 7 illustrates an example interface through which an administrator may view how a software application is performing with respect to the metrics referenced in a goal definition, according to one embodiment.

FIG. 8 illustrates a process for a decision-making agent to integrate active decision-making functionality into a computing analytics framework, according to one embodiment.

FIG. 9 illustrates a process for a monolithic client to integrate active decision-making functionality into a computing analytics framework, according to one embodiment.

FIG. 10 illustrates a process for a policy generator, according to one embodiment.

FIG. 11 illustrates a process for an interface component, according to one embodiment.

FIG. 12 illustrates an example message flow diagram of communications between a back-end system, a decision-making agent, a server-side application, and an endpoint device in which synchronous decision-making functionality is integrated in a computing analytics framework, according to one embodiment.

FIG. 13 illustrates an example message flow diagram of communications between a back-end system, a decision-making agent, a server-side application, and an endpoint device in which asynchronous decision-making functionality is integrated in a computing analytics framework, according to one embodiment.

FIG. 14 illustrates an example message flow diagram of communications between a back-end system, a server-side application, and an endpoint device executing a monolithic client in which asynchronous decision-making functionality is integrated in a computing analytics framework, according to one embodiment.

FIG. 15 illustrates an example message flow diagram of communications between a back-end system, a decision-making agent, a server-side application, and an endpoint device executing a thin client in which asynchronous decision-making functionality is integrated in a computing analytics framework, according to one embodiment.

FIG. 16 illustrates a process for a decision-making agent to integrate speculative decision-making functionality into a computing analytics framework, according to one embodiment.

FIG. 17 illustrates an example message flow diagram of communications between a back-end system, a decision-making agent, a server-side application, and an endpoint device in which speculative decision-making functionality is implemented, according to one embodiment.

FIG. 18 illustrates an example message flow diagram of communications between a back-end system, a decision-making agent, a server-side application, and an endpoint device in which event observations are reported to the back-end system by the server-side application and the endpoint device, according to one embodiment.

FIG. 19a illustrates an example message flow diagram illustrating hybrid observation reporting from an endpoint device in a decision-making system, according to one embodiment.

FIG. 19b illustrates an example message flow diagram illustrating hybrid observation reporting from a customer server in a decision-making system, according to one embodiment.

FIG. 20 illustrates a decision-making system, according to an embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments presented herein provide structures and functionality for transforming passive analytics systems into decision-making systems (and/or recommendation systems) that can actively modify software behavior based on analytic data to improve software performance relative to configurable goal metrics. Specifically, embodiments presented herein introduce a set of software abstractions and concepts for transforming an analytics system into a decision-making system. The present disclosure explains how these software abstractions and concepts can be applied in a manner that seamlessly extends existing analytics application programming interfaces (APIs), thereby adding goal-centered interventional capability to analytics systems. By extending those APIs, examples described herein preserve the integration simplicity those APIs provide. As a result, software developers who are familiar with analytics APIs can readily access the functionality provided by the embodiments described herein without having to familiarize themselves with unfamiliar programming languages, proprietary interfaces, or esoteric platforms.

The present disclosure provides several illustrative, concrete examples of how concepts disclosed herein can be applied. However, the concepts disclosed herein can be readily applied in any scenario that involves an interaction between a human and software (or an interaction between two pieces of software), uncertainty about at least one outcome of the interaction, sequential decision-making during the interaction related to the outcome, and at least one quantifiable goal by which the decision-making performance (e.g., relative to the outcome) is evaluated.

The present disclosure also describes certain elements for supporting the decision-making systems and recommendation systems described herein. For example, the present disclosure describes containers (referred to herein as “sessions”) for storing time-series data (e.g., describing events that occur or commence at defined times) associated with consumers of an application. The container for a given consumer may include time-series data collected over a long period of time during multiple interactions occurring on different devices between consumers and software. Also, systems described herein allow administrators to define custom goals based on custom metrics and to set hazard levels and target levels for those metrics. Based on the time-series data and the goal-metric settings, systems described herein can generate a decision-making policy tailored to ensure the hazard levels for the metrics are satisfied and that target levels are prioritized. The policy can be deployed to a decision-making agent or client devices and applied during interactions to which the policy pertains. When an event that calls for a decision about how a software application will behave occurs, the policy dictates one or more actions for the software to perform based on the time-series data preceding the event. Furthermore, systems described herein continuously optimize as the time-series data in session containers evolves over time and goal-metric settings are added, removed, or de-prioritized by producing updated decision-making policies to ensure the hazard levels and target levels are respected. Further, the decision-making policy may allow for the speculative generation and pre-computation of one or more actions for the software to perform in response to the detection of one of a set of events that are expected to be observed in user interaction with a software application.

The present disclosure also describes a novel scheme for plotting metrics for sessions. Sessions are grouped into bins, where each bin corresponds to a respective time interval with definite starting time and a definite ending time. Each session is grouped into a bin according to the session's starting time. However, the sessions themselves are not required to have definite ending times and metrics are calculated based on all the data in the sessions—even data describing events that occur after the ending times of the bins into which the sessions are grouped. As a result, the average metric value for sessions in a bin can reflect events that occur after the ending time of the bin. As the sessions in a bin are continuously updated with new time-series data, the average metric value for the sessions in the bin can be updated in a live manner even after the ending time of the time interval corresponding to the bin. This updated metric value can be reflected on a plot that is also updated in a live manner. The time intervals that correspond to the bins and the start times of the sessions do not change, though, so the set of sessions grouped into a bin remains consistent regardless of how many times the metric values are updated.

A great deal of modern software is designed to interact with humans or other types of software in one way or another. Video games, for example, are designed to receive input from users (e.g., via touch screens, microphones, keyboards, etc.), update game states based on the input, and present output to the users in response to the input. Other computer programs, such as bots, may be designed to interact directly with software rather than with humans. Regardless of whether such software is meant to interact with a human agent or a software agent (or both), the interaction can be modeled as a simple multi-agent system which includes the software application being optimized and the consumer (the consumer, such as a human user or another piece of software). During the interaction, the consumer can choose to respond to the software in a variety of ways. Some of the possible consumer responses may fulfill a goal specified for the software, while other possible consumer responses may not. As a result, from the perspective of the software, there is uncertainty about whether a goal that is dependent on the consumer's responses will be fulfilled.

Despite this uncertainty, the way the software behaves during interactions with the agent may influence the probability that the goal will be fulfilled. For example, throughout a series of interactions with an agent, the information the software chooses to present to the agent, the format in which the software presents the information, the order in which the software presents the information, the speed with which the software presents the information, and many other factors that can be controlled unilaterally by the software may make it more or less likely that the agent will perform a response on which a particular goal depends. If the software can be configured to behave in a way that increases the odds that the goal will be fulfilled, vendors who designed the software for the purpose of fulfilling the goal stand to benefit greatly.

However, depending on the nature of the goal, the identity of the agent, and other factors, there may not be an a priori way to tell how different variants of software behavior will influence the probability that a specific goal will be fulfilled. Therefore, many software vendors use analytics tools to gather empirical data about how agents respond when software behaves in different ways or presents different variants of content. Once such empirical data is available, data scientists inspect the data. Data scientists may apply statistical and machine-learning techniques to the data to discover patterns and correlations between software behavior and metrics of interest. After such an analysis is completed, data scientists may draw conclusions about what the data reflect and about which types of behavior better serve specified goals. Based on those conclusions, data scientists may provide recommendations about which behavioral modifications and content variants to adopt in the software for the long term.

Several state-of-the-art machine-learning models that are trained on such empirical data are created using a “point-in-time” reward concept in which a metric that is used as a label for training instances generated from the empirical data is determined only once, at a single point in time during a session or interaction. However, in reality, some metrics may change over time. For example, suppose ten thousand people may initially ignore an ad presented in a sidebar their mobile devices, but eventually decide to purchase an item shown in the ad several days later from their desktop computers. If separate training instances are generated for interactions on the mobile devices and interactions on the desktop computers, the training instances have labels that erroneously suggest that the ads presented on the mobile devices did not produce any revenue. If such erroneously labeled training instances are used to train a machine-learning model, a data scientist evaluating the composition and output of the machine-learning model may erroneously conclude that advertising the item on mobile devices is ineffective—even if presenting the ad on the mobile devices was actually a proximate cause of the purchases.

Systems of the present disclosure, however, address this issue by recalculating metrics for sessions over time, updating the training instances generated from those sessions, and retraining a machine-learning model with the updated training instances. The sessions are not required to have ending times and can contain time-series data gathered across multiple devices, so the training instances reflect—and the machine-learning model trained thereon capture—time-lagged relationships that existing analytics approaches may fail to detect.

A/B testing, also called split testing or bucket testing, is one example method for gathering empirical data. In an A/B test, a first version of a web page or an app screen is modified to create a second version. The first version is presented to a first subset of the users who visit the web page or app screen, while the second version is presented shown to a second subset of the users. User actions for both subsets are recorded and compared.

However, A/B testing typically shows differences across an entire population of users. In some cases, the relationship between the version presented to a user and a desired outcome may be more complicated than population-wide averages may suggest. Within the population of users, there may be many groups of users that have different characteristics. A larger group of users may respond more favorably to the first version, while a smaller group of users may respond more favorably to the second version. However, the preference of the smaller group may be drowned out if only population-wide averages are calculated. While some analytics platforms may allow an administrator to specify a segment (e.g., group) of users of interest, the administrator typically has to have some a priori knowledge of how to define the segments beforehand. Analytics platforms lack the ability to actively discover segments of users for whom the second version yields a desired outcome more reliably than the second version. By contrast, systems of the present disclosure can actively discover such segments without requiring input from an administrator.

Another disadvantage to existing analytics approaches is that they take a relatively long time to gather a statistically significant amount of empirical data. Once the data has been gathered, it takes data scientists additional time to train machine-learning models, glean insights from the data, and formulate recommendations. The time delay may translate to lost opportunities with users who abandon the software before the data scientists finish formulating their recommendations. The time delay also poses a problem because user preferences and user demographics may change over time. As a result, by the time developers finish making changes to software based on recommendations from data scientists, those recommendations may already be obsolete.

Thus, existing approaches that use analytics data and machine-learning models may be inadequate in scenarios where time is of the essence. As an example, consider a scenario in which a new mobile application is released. During the first few days after a new mobile application is released, users that like to try out new applications tend to be the first ones to download the new app. Those users may convert into regular users of the app or may abandon the app shortly after the first use. Studies have shown that the long-term success of new apps hinges on how this first group of users responds.

If a sufficient number of users in the first group converts, the app begins to be noticed by a second, broader group of users who hear about the app from the first group (e.g., via blogs, online reviews, word of mouth, etc.). Users in the second group decide to try the application, convert, and spread the word about the new app. A snowball effect occurs as the app becomes more recognized and popular, leading to sustained long-term commercial success of the app.

However, if an insufficient number of users in the first group converts, the second group may decide not to try the app at all after hearing negative or lukewarm reviews from the first group. In some cases, the second group may not hear about the app at all. Negative reviews and a lack of popularity may cause the app to be pushed to the bottom of app store search results, further reducing the odds that new users will discover and try the app. New users may collectively opt to try competitor apps that appear near the top of app store search results. Ultimately, a failure to achieve a sufficient conversion rate among the users in the first group frequently leads to commercial failure of the app.

For this reason, the first few days after an app is released are a pivotal time window in which to achieve a high conversion rate amongst the first group of users. However, because this pivotal time window typically begins when the app is released and ends only a few days later, it is difficult to collect a sufficient number of samples to use A/B testing with statistical significance. Since the app is new, there is no preexisting data available for analysis or for training a machine-learning model. By the time enough data has been gathered for data scientists to identify which of several alternative ways of presenting the app results in an increase in the conversion rate, the pivotal time window—and the opportunity for the app to achieve lasting commercial success—may have passed.

As another example in which time is of the essence, consider a scenario in which a software vendor wants to introduce a noticeable change in the appearance or functionality of an existing application (e.g., by adding a new button or reorganizing a graphical user interface). Once the change is deployed, existing users of the app may or may not respond positively. For example, if the change involves substantial modifications to an existing interface, users who are more familiar with a previous version may find the interface confusing. Those users may abandon application altogether because of the changes. This loss of existing customers may prove costly for the software vendor, since studies have shown that the cost of attracting a new customer is about 400% higher than the cost of retaining an existing customer. The longer it takes for empirical data to be collected, an analysis to be made, and a recommendation to be implemented, the more existing customers may be lost.

Systems of the present disclosure are better suited for scenarios in which time is of the essence than existing analytics systems. Existing analytics systems are not equipped to provide actionable insights quickly enough for changes to be made in time to affect the response of users in the first group. By contrast, the systems described herein can detect trends quickly and continually update policies for controlling software behavior quickly enough to affect the response of users in the first group.

Specifically, the systems described herein can automatically detect which variants of software behavior and content are effective for achieving specific goals among different subgroups of users (or other agents with whom the software interacts) that the system actively discovers, automatically generate a policy dictating how the software is to behave when interacting with agents in each subgroup to facilitate achievement of the goals, and automatically deploy the policy for use in the software without requiring intervention or analysis by data scientists or developers. Once the policy is deployed, the systems described herein can apply the policy to control software behavior at remote devices with near-zero latency (e.g., taking less than 100 milliseconds to complete a decision on a remote device). As more empirical data becomes available, the system can automatically update the policy at regular intervals without human intervention to ensure that the policy evolves quickly in response to changing trends reflected in the data.

After an administrator has defined the goals, the administrator can edit, adjust, or redefine the goals at will. Each time the goals are edited, the system can repeat the process of generating, updating, and deploying the policy continually without the need for human intervention. Often, a single iteration of the process can be completed in a matter of minutes. As a result, in scenarios where time is of the essence, systems described herein can detect trends and update policies for controlling software behavior very quickly in response to those trends and in response to changes in the goals.

Another problem with existing analytics systems is that they are passive. In other words, existing analytics systems can collect observations (e.g., of events) from software and relay those observations to an administrator, but existing analytics systems lack integrated decision-making functionality for active, dynamic control of the software that reports the observations. Since no decision-making functionality is integrated into existing analytics systems, data scientists and developers are obliged to intervene manually for benefits from the analytics system to be realized by the software from which the analytics system collects observations. Specifically, data scientists analyze the data (e.g., by training machine-learning models) and form recommendations. Developers encode changes based on those recommendations into the software itself or use a fixed model provided by the data scientists. As explained above, the manual intervention steps can cause a significant delay between the time observations are made and the time software behavior is adjusted to reflect insights gained from those observations. Manual intervention also makes existing solutions more complicated, less efficient, and less scalable. Furthermore, manual intervention is highly error prone.

One obstacle that discourages integrating decision-making functionality with analytics systems, though, is latency. An analytics system is typically remote relative to the devices that run the software from which the analytics system receives observation data. The software reports those observations to the analytics system via a network (e.g., the Internet). If the analytics system is merely receiving observations from the software, network latency is unlikely to affect the quality of experience (QoE) for a user interacting with the software. However, if the software depends on the analytics system to decide what action the software performs in response to an event, the software may be obliged to send a decision request to the analytics system via the network and wait for a response from the analytics system before the action can be completed. Network latency may cause a noticeable delay before the software performs the action, resulting in a decreased QoE for the user.

Systems described herein integrate automated decision-making functionality and analytics functionality in a single system and obviate the need for manual intervention to realize benefits from analytics data in the software from which the data is collected. Furthermore, the present disclosure provides several different examples of infrastructure arrangements that can be used to implement the systems described. These infrastructure arrangements allow the decision-making functionality to operate with near-zero latency.

Existing analytic systems also lack a way for administrators to define custom metrics and custom goals that are multivariate functions of those custom metrics. By contrast, systems described herein allow administrators to define custom metrics and custom goals that are functions of those metrics. Furthermore, systems described herein allow administrators to integrate hazard levels and target levels for the custom metrics into the custom goal definitions and to generate policies to govern software behavior in accordance with the custom goals.

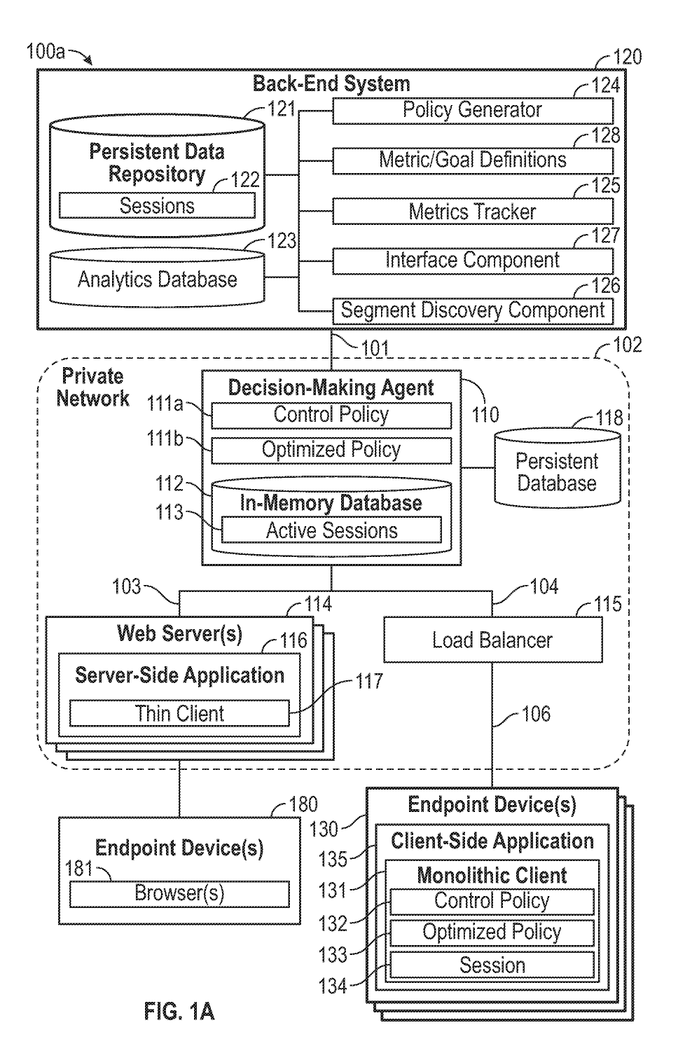

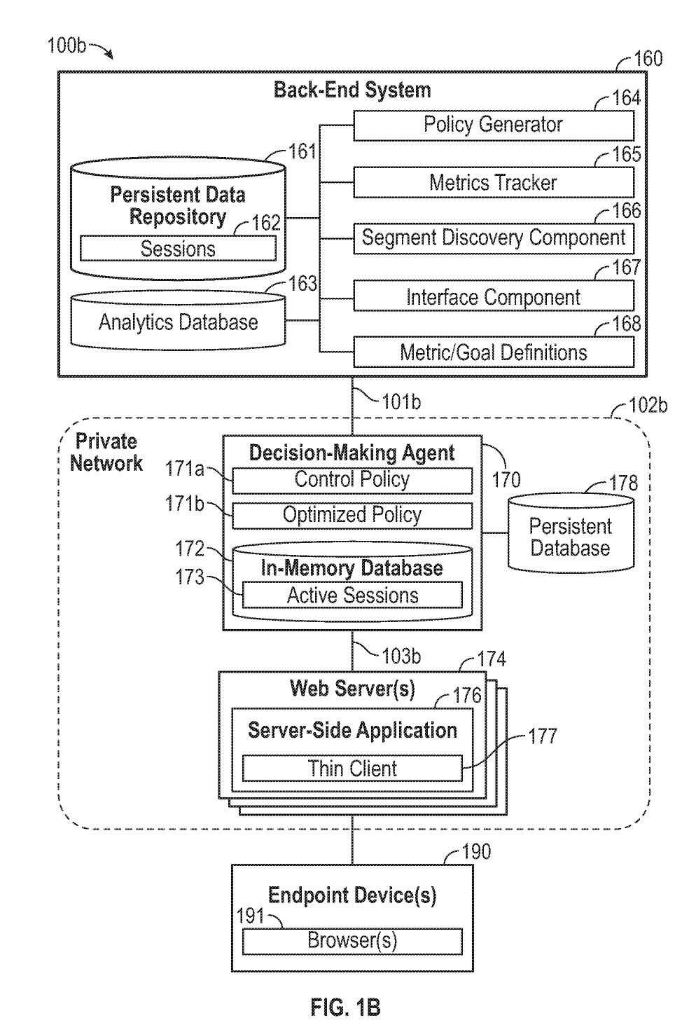

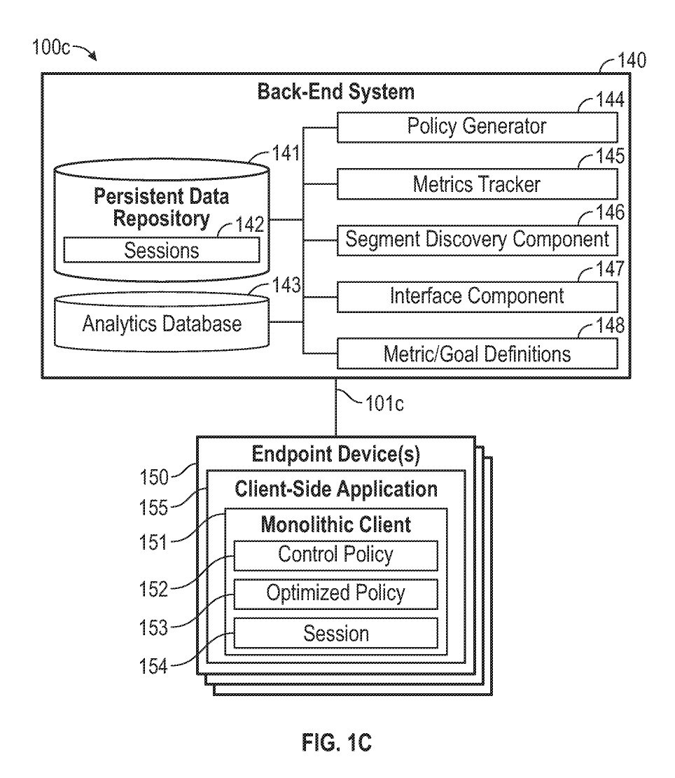

FIG. 1a illustrates a first example computing environment 100a in which systems of the present disclosure may operate, according to one embodiment. As shown, the computing environment 100a includes a back-end system 120, a decision-making agent 110 executing in a private network 102, web server(s) 114 in the private network 102, and endpoint device(s) 130. In one embodiment, back-end system 120 is a distributed cloud-computing system. Endpoint device(s) 130 may represent any type of client endpoint device, such as a mobile phone, a laptop computer, a desktop computer, a tablet computer, or in Internet-of-Things (IoT) device. The private network 102 may be an enterprise private network (EPN), a local area network (LAN), a campus area network (CAN), a virtual private network (VPN), or some other type of private network.

Server-side application 116 represents a software application executing on web server(s) 114. Server-side application 116 includes a thin client 117 that is specific to a programming language. The thin client 117 allows the server-side application 116 to communicate with the decision-making agent 110 by wrapping application programming interface (API) communications between the decision-making agent 110 and the server-side application 116. The thin client 117 includes code for reporting time-series event data and other usage data to the decision-making agent 110 via a private network connection 103. While only one instance of the server-side application 116 and only one thin client 117 are shown in FIG. 1a, persons of skill in the art will understand that additional servers represented by web server(s) 114 may have different versions of the thin client 117 for different programming languages, respectively.

Client-side application 135 represents a software application executing on endpoint device(s) 130. Client-side application 135 includes code for reporting time-series event data and other usage data to the back-end system 120 via the network connection 106, the load balancer 115, and the network connection 104. Client-side application 135 includes a monolithic client 131 that can make decisions locally without requiring input from the decision-making agent 110. The monolithic client 131 allows the client-side application 135 to communicate with the decision-making agent 110 to report time-series data to the back-end system 120. While only one instance of the client-side application 135 and only one monolithic client 131 are shown in FIG. 1a, persons of skill in the art will understand that additional endpoint devices represented by endpoint device(s) 130 may have versions of the monolithic client 131 that are specific to the types of the additional endpoint devices, respectively.

The time-series event data reported to the back-end system 120 may include descriptions of events that occur while the server-side application 116 and the client-side application 135 interact with consumers and timestamps indicating when the described events occurred. The consumers may access the server-side application 116 via the browser(s) 181 executing on the endpoint device(s) 180. Depending on the nature of the server-side application 116 and the client-side application 135, many different types of events may occur. For example, document object model (DOM) events such as mouse events, touch events, keyboard events, form events, and window events may be recorded. In other examples, other types of events may be detected and reported.

Some event types trigger responses from the server-side application 116 (or the client-side application 135). For example, if a user clicks on a “next” button shown on a page or screen of the server-side application 116 (or the client-side application 135), the server-side application 116 (or the client-side application 135) may respond by navigating to a subsequent page or screen of the server-side application 116 (or the client-side application 135). The user, referred to herein as a “consumer,” may be a person (e.g., accessing the server-side application 116 via a browser or accessing the client-side application 135 directly) or another piece of software.

Some event types may be designated as decision-point event types. Decision-point events trigger responses from the server-side application 116 (or the client-side application 135), but the response of the server-side application 116 (or the client-side application 135) to a decision-point event does not have to be deterministically decided beforehand. Instead, when a decision-point event is detected at the server-side application 116, the server-side application 116 sends a decision-making request to the decision-making agent 110 via the thin client 117. In response, the decision-making agent 110 selects one or more actions for the server-side application 116 to perform based on either the control policy 111a or the optimized policy 111b (as described in greater detail below) and sends an indication of the one or more selected actions to the server-side application 116. The server-side application 116 performs the selected actions in response to the decision-point event.

When a decision-point event is detected at the client-side application 135, the monolithic client 131 selects one or more actions for the client-side application 135 to perform based on either the control policy 132 (which is a locally stored copy of the control policy 111a) or the optimized policy 133 (which is a local copy of the optimized policy 111b). The client-side application 135 performs the selected actions in response to the decision-point event.

The manner in which the decision-making agent 110 and the monolithic client 135 operate and the manner in which the optimized policy 111b is generated are discussed in greater detail below after other elements, such as the policy generator 124 and the sessions 122, are described. The decision-making agent 110 reports decision-type events and the actions performed in response to those decision-point events to the back-end system 120. The decision-making agent 110 also has a replay queue to hold requests when a network connection is unavailable and send the requests once the network connection is available.

In the back-end system 120, the data reported by the decision-making agent 110 is organized into sessions 122 and stored in the persistent data repository 121. Each of the sessions 122 maps to a specific consumer of the server-side application 116 and/or the client-side application 135. Each time the consumer logs in to the server-side application 116 or the client-side application 135, the time-series event data (e.g., including a timestamp indicating when each event occurred) describing the consumer's interactions with the server-side application 116 or the client-side application 135 is stored in the session corresponding to the consumer. Hence, if the consumer logs in to the server-side application 116, the consumer's interactions (e.g., time-series event data) with the server-side application 116 are recorded in the session corresponding to that consumer. If the same consumer also logs in to the client-side application 135 on endpoint device 130, the consumer's interactions with the client-side application 135 are also recorded in the session corresponding to the consumer. Thus, the data in each of the sessions 122 can be collected across multiple different devices from which the consumer accesses the server-side application 116 or the client-side application 135.

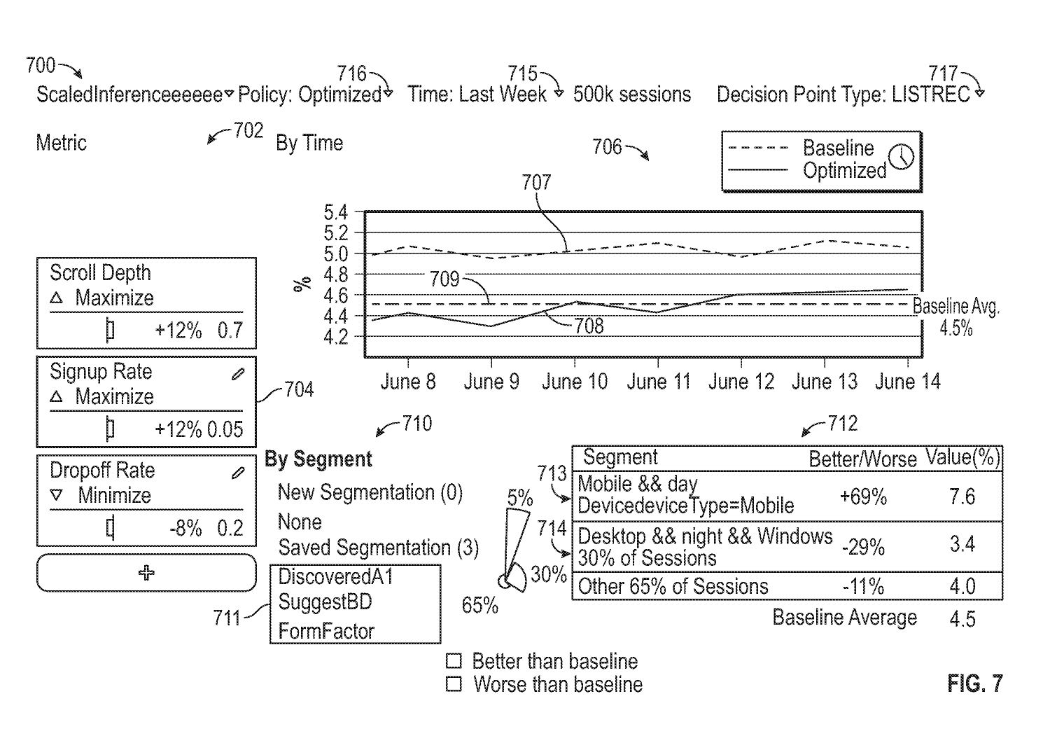

In addition, each of the sessions 122 has a definite starting time (e.g., a timestamp representing when the consumer created a login account for the server-side application 116 and the client-side application 135). However, unlike sessions that are used in conventional analytics systems, the sessions 122 are not constrained to definite ending times. Sessions used by conventional analytics systems typically end after 30 minutes of inactivity (or, at most, one day regardless of activity). By contrast, the sessions 122 can include data gathered across days, weeks, months, years, or even longer if desired. No session-end event is needed for any of the sessions 122 because sessions, as defined herein, do not have to have ending times. This lack of a required ending-time constraint makes the sessions 122 suitable for data analysis via “live” metrics (e.g., as explained in greater detail with respect to FIG. 7).

When an administrator wants to analyze the data in the sessions 122, the administrator can begin by providing metric/goal definitions 128 via the interface component 127. A metric definition is a logical or mathematical expression which includes one or more parameters whose values can be determined based on the data contained in the sessions 122. When an expression that defines a particular metric is evaluated using arguments (i.e., actual parameters) for a particular session (or group of sessions), the output is the value of the metric for that session (or group of sessions). Of course, preexisting common or default metric definitions may also be included in the metric/goal definitions 128 so that the administrator does not have to re-create definitions created by others.

For each of the sessions 122, the metrics tracker 125 calculates a value of each metric as defined in the metric/goal definitions 128. The metrics tracker 125 indexes and stores the calculated values in the analytics database 123. In addition to the values of the metrics, the metrics tracker 125 may also calculate other features of the sessions 122 and store those features in a flattened, indexed format in the analytics database 123.

A goal definition comprises a logical or mathematical expression which uses selected metrics as parameters. As explained above, the values of those metrics can be determined based on the data contained in the sessions 122. The goal definition specifies an optimization direction for each selected metric. The optimization direction for a metric indicates whether the administrator wants the metric value to increase or decrease. For example, a goal definition may indicate that an administrator wishes for a metric such as “total revenue” to increase. On the other hand, the goal definition may indicate the administrator wishes for a metric such as “dropoff rate” to decrease.

A goal definition may also include a hazard condition for one or more of the selected metrics. If the optimization direction for a metric is upward (i.e., the administrator wishes for the metric to increase), the hazard condition specifies a threshold minimal level of the metric. If the value of the metric falls below the threshold minimal level, the decision-making agent 110 may revert to a default decision-making methodology (e.g., as contained in the control policy 111a). Conversely, if the optimization direction for a metric is downward (i.e., the administrator wishes for the metric to decrease), the hazard condition specifies a threshold maximum level of the metric. If the value of the metric falls exceeds the threshold maximum level, the decision-making agent 110 may revert to a default decision-making methodology (e.g., as contained in the control policy 111a). Reverting to a default methodology when the hazard condition is not satisfied can be used as a safety measure (e.g., if the optimized policy 111b is temporarily performing poorly for some reason).

A goal definition may also include a target condition for one or more of the selected metrics. If the optimization direction for a metric is upward (i.e., the administrator wishes for the metric to increase), the target condition specifies a target level of the metric such that increases to the metric beyond the target level are not of value to the administrator. If the optimization direction for a metric is downward (i.e., the administrator wishes for the metric to decrease), the target condition specifies a target level of the metric such that decreases to the metric beyond the target level are not of value to the administrator. An administrator can use a target condition to specify a point at which the marginal utility for a metric asymptotically decreases.

In addition, the goal definition may specify an order of priorities for the selected metrics. The order of priorities ranks the selected metrics in order of importance to the administrator. If the time series-data in the sessions 122 demonstrates that there is a tradeoff relationship between two of the selected metrics (e.g., as in when two metrics with the same optimization direction are inversely correlated or when the edge of a Pareto frontier is reached with respect to the two metrics), the order of priorities establishes which of the two metrics takes priority for the purposes of policy generation.

There are a number of ways to incorporate the order of priorities into an expression that represents the goal definition. In one example, suppose the goal definition is a function G(M₁, M₂, . . . , Mₙ) that, when evaluated using n metric values M₁, M₂, . . . , Mₙ (where n is a positive integer), outputs a goal score. Also suppose that the position of each metric in the order of priorities matches the subscript of the metric (i.e., M₁ has first priority, M₂ has second priority, Mₙ has last priority, etc.). In this example, the goal score may be defined as:

$$G ( {M}_{1} , {M}_{2} , … , {M}_{n} ) = {\sum }_{i = 1}^{n} {W}_{i} ,$$

where Wᵢ is a weight construct for i^{th} metric Mᵢ. Also suppose Bᵢ is a Boolean value that equals 1 if the hazard condition for Mᵢ is satisfied and 0 otherwise. Furthermore, suppose Tᵢ is a Boolean value that equals 1 if the target condition for Mᵢ is satisfied and 0 otherwise. Also suppose that if Tᵢ=1, then Bᵢ=1. Also suppose βᵢ is the hazard level for Mᵢ, τᵢ is the target level for Mᵢ, and βᵢ≠τᵢ. In addition, suppose j is a positive integer such that j<i. In this example, to incorporate the order of priorities into the goal definition, the weight construct W_{L} can be defined in the following manner:

$${W}_{i} \{ \begin{matrix}0 , & ∃ j \text{:} {B}_{j} = 0 \\ - i , & ( {B}_{i} = 0 ) ⋂ ( ∄ j \text{:} {B}_{j} = 0 ) \\ {( \frac{{M}_{i} - {β}_{i}}{{τ}_{i} - {β}_{i}} )}^{2} , & ( ∄ j \text{:} {B}_{j} = 0 ) ⋂ ( {B}_{i} = 1 ) ⋂ ( {T}_{i} = 0 ) \\ 1 , & ( ∄ j \text{:} {B}_{j} = 0 ) ⋂ ( {B}_{i} = 1 ) ⋂ ( {T}_{i} = 1 )\end{matrix}$$

Note that the weight construct Wᵢ can be defined in other ways without departing from the scope of this disclosure, particularly in cases where not every metric has a target level. Regardless of how the weight constructs are defined, the weight constructs adjust the contribution of each metric to the goal score based on whether metrics with higher priority meet corresponding hazard conditions and based on whether the metric meets a corresponding target condition.

Once the metric/goal definitions 128 have been established, the policy generator 124 creates a set of training data for training a machine-learning model. The training data includes training instances that correspond to decision-point events recorded in the sessions 122. To a training instance corresponding to a particular decision-point event, the policy generator 124 determines values for the selected metrics (and, optionally, a goal score) based on the entire set of time-series data in the session container in which the decision-point event is recorded—including data that describes events that occurred after the decision-point event. The determined values for the selected metrics (and the goal score) for the session container serve as labels for the training instance. The input features for the training instance include the type of the decision-point event and the actions performed in response to the decision point event. Additional input features may also be determined for the training instance. However, unlike the values for the selected metrics, the additional features are determined based only on events recorded in the session container that occurred before the decision-point event, not after. This is to ensure that the machine-learning model will be trained to predict the values for the selected metrics (or the goal score) that will result if the actions are performed in response to future decision-point events of the same type without requiring information that may not be available when those future decision-point events occur.

The additional features may include details about previous decision-point events recorded in the session container, such as the types of the previous decision-point events, the actions taken in response to the previous decision-point events, and the difference between the timestamps of the previous events and a timestamp for the decision-point event that corresponds to the training instance. This is to ensure that the machine-learning model will have sufficient information to capture dependencies between sequences of decision-point events, the actions taken in response to those events, and the values for the selected metrics (or the goal score).

Once the policy generator 124 has created the set of training data, the policy generator 124 trains a machine-learning model on the set of training data. During the training process, the machine-learning model “learns” logic that specifies relationships between the input features and the selected metrics (or the goal score). The policy generator 124 can also use this logic to quantify tradeoff relationships between the selected metrics. Upon determining the tradeoff relationships, the policy generator 124 can determine the composition of a Pareto frontier relative to the metrics (i.e., the boundary in multi-metric space beyond which the value for one metric cannot be increased in the optimization direction for that metric without adversely affecting the value of another metric).

Based on the logic learned by the machine-learning model, the policy generator 124 generates the optimized policy 111b. The optimized policy 111b identifies actions which, when performed in response to a decision-point event in a session, are most likely (according to the logic learned by the machine-learning model based on the training data) to improve a goal score for the session given the time-series data contained in the session.

The control policy 111a (“control” as opposed to “experimental” or “optimized”) also identifies actions to be performed in response to decision-point events, but the control policy 111a does not employ the logic learned by the machine-learning model. Instead, the control policy 111a can define default actions to be performed in response to decision-point events. (In other embodiments, the control policy 111a may select the actions at random or according to some other methodology that an administrator wants to compare to the optimized policy 111b). Sessions in which the control policy 111a is applied to determine actions in response to decision-point events serve as a control group of sessions. The distributions of metric values or goal scores for the control group can be compared to the distributions of metric values or goal scores for an optimized group of sessions in which the optimized policy 111b is applied.

The administrator can allocate percentages of the sessions 122 (and/or the corresponding consumers) to the optimized policy 111b and the control policy 111a to define the control group and the optimized group, respectively. In one embodiment, the administrator specifies the percentages via the interface component 127. Once the percentages are allocated, the optimized policy 111b can be generated.

The back-end system 120 deploys the optimized policy 111b and the control policy 111a to the decision-making agent 110 via the network connection 101. The decision-making agent 110 is a software module that executes on hardware within the private network 102. The hardware on which the decision-making agent 110 executes includes at least one or more processors and memory and may be distributed across several different servers, racks, or other physical locations in the private network 102. The back-end system 120 also deploys the optimized policy 111b and the control policy 111a to the monolithic client 131 (e.g., directly or via the decision-making agent 110), where the optimized policy 111b is locally stored as optimized policy 133 and the control policy 111a is locally stored as the control policy 132.

One advantage of having the decision-making agent 110 reside in the private network 102 instead of the back-end system 120 is that there will be lower latency between the decision-making agent 110 and web server(s) 114. This results in lower latency when decision-making functionality is provided to the server-side application 116 via the thin client 117. Furthermore, in some embodiments, the endpoint device(s) on which the client-side application 135 runs may also be included in the private network 102. For example, if the private network 102 is an enterprise network for a large corporation, the corporation may execute the decision-making agent 110 on hardware within the private network 102 to provide low-latency decision-making functionality to server-side versions and client-side versions of an enterprise application running on computing devices within the private network 102.

Once the decision-making agent 110 receives the optimized policy 111b and the control policy 111a, the decision-making agent 110 is ready to provide decision-making functionality to the web server(s) 114. When a decision-point event is detected at the server-side application 116, the thin client 117 sends a decision-making request to the decision-making agent 110 via the network connection 103. In one embodiment, the decision-making request is an API message that includes an identifier of a consumer logged in to the server-side application 116. The decision-making request also indicates the type of the decision-point event so that the type of decision being requested is clear. For example, for some types of decision-point events, the decision-making request may call for a list of items to recommend to the consumer selected from a larger group of candidate items. For other types of decision-point events, the decision-making request may call for a selection of a single content item to present to the consumer from a group of several candidate content items (e.g., background colors, font colors, font types, CSS files, an images, videos, toolbars, product descriptions, and slideshows). For other types of decision-point events, the decision-making request may call for a selection of some other type of action or list of actions to perform in response to the decision-point event.

The decision-making agent 110 includes an in-memory database 112. In one embodiment, the in-memory database 112 is fully or partially contained in random access memory (RAM) or a cache (although storage may be used in alternative embodiments). The in-memory database 112 stores the active sessions 113. In one embodiment, the term “active session” refers to a session in which the latest recorded event occurred less than a threshold amount of time ago. Storing the active sessions in memory reduces latency for decision-making tasks and facilitates session-state synchronization across different platforms. The active sessions 113 are a subset of the sessions 122, so the active sessions 113 are stored in both the persistent data repository 121 and the in-memory database 112.

The decision-making agent 110 identifies a session (from the active sessions 113) that is associated with the consumer ID and retrieves the time-series data contained in the session from the in-memory database 112. One advantage of storing the active sessions 113 in the in-memory database 112 is latency reduction, since the time-series data can be fetched relatively quickly from the in-memory database 112 without requiring communication outside of the private network 102. If the session associated with the consumer ID is not found among the active sessions 113, the decision-making agent 110 may retrieve the time-series data contained in the session from an optional persistent database 118 that may be connected to the decision-making agent 110 within the private network 102. In very rare cases, the time-series data may not be available in the active sessions 113 or in the persistent database 118. In such cases, the decision-making agent 110 may retrieve the time-series data contained in the session from the persistent data repository 121 via the network connection 101. Note that some embodiments do not have to include the persistent database 118.

Once the time-series data from the session associated with the consumer ID has been retrieved, The decision-making agent 110 may first determine whether a decision-making request for the same type of decision-point event has previously occurred within a threshold amount of time by checking the time-series data in the session associated with the consumer ID for prior decision-point events of the same type. This threshold amount of time serves as a Time To Live (TTL) for the decision that was made in response to the previous decision-point event. If the same type of decision-point event did previously occur within the decision TTL, the decision-making agent 110 selects the same actions that were performed in response to the previous decision-point event of the same type to ensure a consistent experience for the consumer.

Otherwise, the decision-making agent 110 determines whether to apply the control policy 111a or the optimized policy 111b. For example, the decision-making agent 110 may input the consumer ID (or another identifier for the session) into a hashing function that randomly assigns the applicable policy. If the control policy 111a is assigned, the decision-making agent 110 selects one or more actions for the application instance 131a to perform based on the control policy 111a. If the optimized policy 111b is assigned, the decision-making agent 110 compares the time-series data and the type of the decision-point event to the optimized policy 111b. Based on the comparison, the decision-making agent 110 selects one or more actions for the application instance 131a to perform in response to the decision-point event. For example, if the optimized policy 111b is represented via a function of features (e.g., the input features of training instances in the training set), the decision-making agent 110 calculates values for those features based on the time series data and evaluates the function using the values as input.

Next, the decision-making agent 110 sends a response message indicating the one or more selected actions to the thin client 117 via the network connection 103. Upon receiving the response message via the thin client 117, the server-side application 116 performs the one or more selected actions and reports the performance to the decision-making agent 110 via the thin client 117.

The decision-making agent 110 updates the session for the consumer in the active sessions 113 to reflect the occurrence of the decision-point event and the performance of the selected actions. The decision-making agent 110 also signals the back-end system 120 to update the copy of the session found in the sessions 122.

Subsequently, when the consumer logs in to the client-side application 135 on the endpoint device(s) 130, the monolithic client 131 records a description of the login event in the session 134. The session 134 is a locally stored copy of the session associated with the consumer. The monolithic client 131 can keep the session 134 synchronized with the session associated with the consumer in the active sessions 113 and the sessions 122 by polling the decision-making agent 110 at a predefined or variable rate. However, if the consumer has not previously logged in to the client-side application 135 at the endpoint device(s) 130, or if the consumer has logged in from a different device since the consumer last logged in at the endpoint device(s) 130, the session 134 may not be synchronized with the session associated with the consumer in the sessions 122 yet. As a result, there may previously recorded time-series data associated with the consumer that has not yet been added to session 134.

For this reason, the monolithic client 131 sends a message to the decision-making agent 110 to report the login event and to request previously recorded time-series data associated with a consumer ID of the consumer in the active sessions 113, the persistent database 118, or the sessions 122 or in. If previously recorded time-series data associated with the consumer ID is currently stored in the active sessions 113, the decision-making agent 110 immediately sends the time-series data to the monolithic client 131 in response to the request. Otherwise, the decision-making agent 110 attempts to retrieve the time-series data from the persistent database 118. If the previously recorded time-series data is not available in the active sessions 113 or the persistent database 118, the decision-making agent 110 requests the previously recorded time-series data from the back-end system 120. The back-end system 120 retrieves the previously recorded time-series data from the sessions 122 in the persistent data repository 121 and sends the previously recorded time-series data to the decision-making agent 110. The decision-making agent 110 copies the previously recorded time-series data into the active sessions 113 of the in-memory database 112 and sends the previously recorded time-series data to the monolithic client 131. The monolithic client 131 adds the previously recorded time-series data to the session 134.

When a decision-point event is detected at the client-side application 135, the monolithic client 131 may first determine whether a decision-making request for the same type of decision-point event has previously occurred within the decision TTL by checking the time-series data in the session associated with the consumer ID for prior decision-point events of the same type. If the same type of decision-point event did previously occur within the decision TTL, the monolithic client 131 may select the same actions that were performed in response to the previous decision-point event of the same type to ensure a consistent experience for the consumer. Otherwise, the monolithic client 131 determines whether to apply the control policy 132 or the optimized policy 133. For example, the monolithic client 131 may input the consumer ID (or another identifier for the session 134) into a hashing function that randomly assigns the applicable policy. If the control policy 132 is assigned, the monolithic client 131 selects one or more actions to perform based on the control policy 132. If the optimized policy 133 is assigned, the monolithic client 131 compares the time-series data in the session 134 and the type of the decision-point event to the optimized policy 133. Based on the comparison, the monolithic client 131 selects one or more actions for the client-side application 135 to perform in response to the decision-point event. For example, if the optimized policy 133 is represented via a function of features (e.g., the input features of training instances in a training set), the monolithic client 131 calculates values for those features based on the time-series data and evaluates the function using the values as input.

In some cases, the monolithic client 131 may not receive the previously recorded time-series data from the decision-making agent 110 before the decision-point event occurs or shortly after. To ensure that the QoE for the consumer is not affected, the monolithic client 131 may, upon determining that a predefined amount of time has passed since the message requesting previously recorded time-series data was sent and that no response to the request has been received, proceed to compare the time-series data in the session 134 and the type of the decision-point event to the optimized policy 133 before receiving a response from the decision-making agent 110. Similarly, if the monolithic client 131 determines that a network connection whereby the decision-making agent 110 can be contacted is unavailable, the monolithic client 131 may proceed to compare the time-series data in the session 134 and the type of the decision-point event to the optimized policy 133. This back-up approach ensures that the decision-making functionality of the monolithic client 131 is robust against network delays or server delays. The monolithic client 131 may also store any unsent polling requests for previously recorded time-series data in a replay queue and send any requests in the replay queue once a network connection to the decision-making agent 110 becomes available.

Next, the client-side application 135 performs the one or more selected actions and reports the performance to the decision-making agent 110 via the monolithic client 131. The decision-making agent 110 updates the session for the consumer in the active sessions 113 to reflect the occurrence of the decision-point event and the performance of the selected actions. The decision-making agent 110 also signals the back-end system 120 to update the copy of the session associated with the consumer ID that is found in the sessions 122.

Thus, although server-side application 116 and the client-side application 135 may execute on machines that use different platforms (e.g., operating systems), the thin client 117 and the monolithic client 131 decision-making agent 110 make policy-based decision-making functionality available for both platforms.

As new time-series data becomes available in the sessions 122, the policy generator 124 creates an updated set of training data based on the new time-series data. The updated set of training data includes training instances for decision-point events that occurred after the previous set of training data was created.

In addition, since the metric values and the goal score for a session may have changed since the previous set of training data was created, the labels of training instances for some decision-points may be different in the updated set. For example, suppose a particular decision-point event was recorded in a session before the first set of training data was generated. Also suppose that the value of a “purchase-dollar-total” metric was zero at the time (meaning the consumer associated with the session had not yet purchased anything through the software application). The training instance representing the decision-point event in the first set of training data would have a label of zero for the “revenue paid” metric. However, after the first set of training data was generated, suppose the consumer purchased something for $50 through the software application. The purchase would be recorded as an event in the session. Subsequently, when the updated set of training data was generated, the label for the updated training instance corresponding to the decision-point event would be 50. However, the input features for the updated training instance would remain unchanged because the purchase occurred after the decision-point event and the actions performed in response to the decision-point event.

Once the policy generator 124 has created the updated set of training data, the policy generator 124 trains an updated machine-learning model on the updated set. Based on the logic learned by the updated machine-learning model, the policy generator 124 generates an updated version of the optimized policy 111b. The policy generator 124 can also deploy the updated version to the decision-making agent 110 and the monolithic client 131 automatically.

The policy generator 124 can continue creating updated training sets, generating updated machine-learning models, and generating (and deploying) updated versions of the optimized policy 111b without requiring any intervention from the administrator. The intervals at which updated policies are deployed may be determined dynamically in the back-end system 120 based on how quickly the data in the sessions 122 changes. For example, if less than a threshold number of events have been recorded in a threshold number of the sessions 122 since the last time a policy was deployed, the policy generator 124 may wait until the thresholds are met before generating an updated version of the optimized policy 111b. On the other hand, if the thresholds are met mere minutes or even seconds since the last time a policy was deployed, the policy generator 124 may proceed to generate an updated version of the optimized policy 111b without delay. (Alternatively, in some embodiments, the intervals at which updated policies are deployed can be fixed). This allows the optimized policy 111b to evolve rapidly based on new trends reflected in new time-series data. The policy generator 124 can also generate an updated version of the optimized policy 111b whenever the administrator modifies the metric/goal definitions 128.

In one embodiment, the interface component 127 can generate graphical plots and other reports summarizing average metric values and goal scores for the sessions 122. In one example, a plot can be generated in the following manner. First, the sessions 122 are grouped into bins. Each bin corresponds to a respective time interval with definite starting time and a definite ending time. In some embodiments, bins may be mutually non-overlapping. Each session is grouped into a bin according to the session's starting time (i.e., a session is grouped into the bin whose corresponding time interval encompasses the starting time). However, the sessions 122 are not required to have definite ending times and metrics are calculated based on all the data in the sessions 122—even data describing events that occur after the ending times of the bins into which the sessions 122 are grouped. As a result, the average metric value for the sessions in a bin can reflect events that occurred after the ending time of the bin. As the sessions in a bin are continuously updated with new time-series data, the average metric value for the sessions in the bin can be updated in a live manner even after the ending time of the time interval corresponding to the bin.

To generate a plot, the bins may be arranged sequentially along a first axis in which units are measured in bins (and therefore time). A second axis may be transverse relative to the first axis. Units of the second axis may be the units used to measure a selected metric (or goal score). Average (e.g., mean, median, mode, percentiles, etc.) values of the selected metric (or goal score) for the sessions in the bins can be plotted against the bins. Specifically, if the optimized policy 111b is applied to a first set of sessions in a bin and the control policy 111a is applied to a second set of sessions in the same bin, average values for both the first and second set can be plotted and labeled accordingly.

As explained above, when the sessions 122 are updated with new time series data, the average values of the selected metric are updated. The plot of the average values, in turn, is also updated to reflect the updated average values even though the time intervals corresponding to the bins remain unchanged. Since the time intervals corresponding to the bins and the start times of the sessions 122 do not change, the sessions grouped into each bin remain consistent regardless of how many times the plot is updated.

The interface component 127 may also provide several different types of previewing functionality and one-click policy-purchase options to the administrator. Specifically, the interface component can preview the performance of candidate policies generated using data gathered over time periods of different lengths, preview the performance of custom policies that are defined manually, and preview the performance of policies with different metric priority levels (e.g., that lie on the edge of a Pareto frontier that defines tradeoffs between the metrics).

To preview the performance of policies generated over time periods of different lengths, the policy generator 124 can begin by generating several candidate policies based on different time periods. Each candidate policy includes logic from a machine-learning model that was trained using training data derived from sessions that commenced during a respective time period corresponding to the candidate policy. The time period for first candidate policy may be subsumed by the time period for a second candidate policy, while the time period for the second policy may be subsumed by the time period for a third candidate policy, and so forth. For example, the policy generator 124 may create a first candidate policy based on a machine-learning model that was trained using training instances corresponding to sessions that commenced during a previous day. The policy generator 124 may create a second candidate policy based on a previous week, a third candidate policy based on a previous month, and so forth.

Once the candidate policies are generated, the metrics tracker 125 can estimate an average value of the selected metric (or goal score) each candidate policy would have achieved if the candidate policy had been applied during the time period corresponding to the candidate policy (e.g., via cross-fold validation or a holdout set). Next, the metrics tracker can determine an estimated difference between the estimated average value for each candidate policy and the average value achieved by the control policy 111a over the time period corresponding to the control policy. The metrics tracker 125 may also determine a confidence level for the estimated difference for each candidate policy. In general, the confidence level increases as the length of the time period corresponding to the candidate policy increases. Hence, the confidence level for the third candidate policy would be higher than the confidence level for the second candidate policy and the confidence level for the second policy would be higher than the confidence level for the third policy. Also, as the length of a time period increases, the amount of training data on which a corresponding candidate policy is based generally increases. More training data not only leads to higher confidence, but also to more accurate machine-learning models (and more accurate policies). As a result, the estimated difference for a candidate policy generally increases as length of the corresponding time period increases. Thus, the estimated difference for the third candidate will likely be higher than the estimated difference for the second candidate policy, while the estimated difference for the second candidate will likely be higher than the estimated difference for the third candidate policy.

Once the estimated difference and the confidence levels have been calculated, the interface component 127 presents the estimated differences and confidence levels for the candidate policies to the administrator. In addition, the interface component also calculates and presents a price for each candidate policy. The price for each candidate policy may be determined by a function of the estimated difference and/or the confidence level for the candidate policy. In one embodiment, the price increases as the estimated difference and/or the confidence level increases. Thus, the third candidate policy would likely have a higher price than the second candidate policy, while the second candidate policy would likely have a higher price than the first candidate policy. The interface component 127 can present a button for each candidate policy to the administrator. By clicking on the button for a particular candidate policy, the administrator can purchase the candidate policy for the associated price. When the button is clicked, the interface component 127 signals the policy generator 124 to deploy the candidate policy to the decision-making agent 110 as an update to the optimized policy 110b.

To preview the performance of a custom policy that are manually defined (either fully or partially), an administrator can define the custom policy manually through the interface component 127. Such a human-guided custom policy may be used for many purposes. For example, suppose the administrator wishes to perform a sanity check to verify that source code in the metrics tracker 125 is calculating performance metrics properly (i.e., without obvious arithmetic errors, values that exceed theoretical limits, etc.). In this example, the administrator can manually define a policy for which the metric values for data over a given time period are calculated independently beforehand, prompt the user interface component 127 to preview the policy's performance using the same time period, and compare the preview output to the values that were calculated beforehand. An administrator may also wish to preview a custom policy for other reasons, such as A/B testing.

The previewing functionality may also preview the performance of candidate policies that automatically are generated based on adjusted goal definitions. The adjusted goal definitions may have priority levels that vary slightly from an initial goal definition by an administrator. Such automatically generated candidate policies may be useful in some circumstances. For example, suppose an administrator provides an initial goal definition that specifies hazard conditions for multiple metrics. In some cases, after the policy generator 124 generates a decision-making policy based on the initial goal definition, the metrics tracker 125 may discover that the policy, when applied in a large number of sessions, fails to satisfy at least one of the hazard conditions on the average.

In some cases, this failure may be due to an unfavorable correlation between two (or more) of the metrics for which hazard conditions are specified. For example, suppose a first metric and a second metric are positively correlated. Also suppose the optimization direction for the first metric is upward, but the optimization direction for the second metric is downward. In this example, the positive correlation between the first metric and the second metric is unfavorable because it results in a tradeoff relationship between the first metric and the second metric. Other unfavorable correlations may exist between metrics referenced in the metric definition. In general, a positive correlation between two metrics is unfavorable if the optimization directions for the two metrics are opposite. By contrast, a negative correlation between two metrics is unfavorable if the optimization directions for the two metrics are the same.

Such unfavorable correlations between the metrics may make it impractical to create a policy that can satisfy all the hazard conditions specified in the initial goal definition on the average. (In formal terms, a Pareto frontier that defines tradeoffs between the metrics may exist and the combination of hazard conditions specified in the initial goal definition may lie beyond the Pareto frontier.) However, when such unfavorable correlations exist between metrics, it may still be possible to create candidate alternative policies that satisfy at least some of the hazard conditions of the initial goal definition. For example, if at least one of the hazard conditions is relaxed (i.e., adjusted to be easier to satisfy), the policy generator 124 may be able to generate a candidate policy that satisfies the relaxed hazard condition and the other hazard conditions as initially specified on the average. If the optimization direction for a metric is upward, the hazard condition for that metric can be relaxed by reducing a hazard level specified by the hazard condition. On the other hand, if the optimization direction for a metric is downward, the hazard condition for that metric can be relaxed by increasing a hazard level specified by the hazard condition.

When the metrics tracker 125 detects that a generated policy has failed to satisfy at least one hazard condition specified in an initial goal definition, the policy generator 124 can create several different alternative goal definitions. For example, if there are n hazard conditions (n being an integer greater than zero), the policy generator 124 can create n alternative goal definitions. Each alternative goal definition may include one relaxed hazard condition, yet include the other n−1 hazard conditions as originally specified in the initial goal definition.

Next, the policy generator 124 can generate a corresponding candidate policy based on each alternative goal definition and preview how each candidate policy would have performed if applied during a specific time period, such as a time period over which the original policy based on the initial goal definition was applied. The interface component 127 can present the previewed performances of the candidate policies and descriptions of the corresponding alternative goal definitions to the administrator. This obviates any need for the administrator to manually experiment with different goal definitions to find a goal definition that a policy can satisfy on the average.

Again, the interface component 127 can present a button for each candidate policy to the administrator. By clicking on the button for a particular candidate policy, the administrator can purchase the candidate policy for the associated price. When the button is clicked, the interface component 127 signals the policy generator 124 to deploy the candidate policy to the decision-making agent 110 as an update to the optimized policy 110b.

In addition, the segment discovery component 126 can determine average values of the selected metrics for subsets of the sessions 122 (or the corresponding consumers) known as segments. In the analytics field, a segment comprises one or more non-destructive filters (i.e., filters that do not alter the data to which the filters are applied) against the time-series data in the sessions 122 and/or the data derived therefrom in the analytics database 123. If an administrator wishes to view average metrics for a particular segment, the administrator can manually define the segment by specifying the filters that define the segment via the interface component 127. In addition, unlike existing analytics systems, the segment discovery component 126 provides functionality for actively discovering segments of interest and sequential patterns in events without any intervention from the user.

The segment discovery component 126 can operate in different ways depending on whether decision-point events have been integrated into the sessions 122. To discover segments of interest before integration of decision-point events (i.e., the pre-decision case), the segment discovery component 126 calculates overall (e.g., lobal) average values of the selected metrics (or the goal score) for the sessions 122 (or a portion thereof).

Next, the segment discovery component 126 searches through the space of possible segments. The number of possible segments is exponentially large, so an exhaustive search through the space of all possible segments may be computationally impractical. Hence, the segment discovery component 126 may perform a heuristic-based search or a model-based search (e.g., as described in greater detail with respect to FIG. 7).

For each segment analyzed in the search, the segment discovery component 126 determines average values of the selected metrics for the segment. If at least one of the average values of a selected metric for the segment differs from the overall average value of the selected metric by more than a threshold amount, the segment discovery component 126 adds the segment to a list of segments of interest. The interface component 127 may present the segments to the administrator (e.g., by showing the filters the segment comprises and showing the differences between the average values for the segment and the overall average values).

By discovering segments of interest automatically, the segment discovery component 126 can help the administrator identify meaningful patterns that reflect how consumers respond to a software application (e.g., server-side application 116 or client-side application 135) under different circumstances. For example, suppose a segment in which user devices are running a certain operating system has a poor average value for a particular metric. The administrator may be able to infer that the software application has a previously undiscovered compatibility problem with the operating system. In this manner, when the interface component 127 notifies the administrator about a segment of interest, the administrator can infer actionable insights when inspecting the filters for the segment.

Specifically, the segments discovered in the pre-decision case can help an administrator identify where and how decision-point events should be integrated. For example, upon seeing consumers in a particular segment respond poorly to a particular action, the administrator and integrate a decision-point event type that enables alternative actions to be performed in place of the particular action based on context.

After a decision-point event type has been integrated in this manner (i.e., in the post-decision case), the segment discovery component 126 can operate in a different manner. Specifically, once the decision-point event type has been integrated, the policy generator 124 can configure the optimized policy 111b to leverage decision-point events to improve how the server-side application 116 and the client-side application 135 perform relative to the metric/goal definitions 128.

Next, the metrics tracker 125 can determine metric values for the optimized group (e.g., sessions in which the optimized policy 111b was applied) and metric values for the control group (e.g., sessions in which the control policy 111a was applied) on a segment-by-segment basis. The interface component 127 allows the administrator to select a segment and view compare the metric values for the optimized group to metric values for the control group within the selected segment. If the comparison reveals a large difference in the metric values for the two groups within the segment, the administrator may conclude that applying the optimized policy 111b to events of the decision-point event type is effective for improving metric values within that segment. On the other hand, if the comparison reveals a miniscule difference in the metric values for the two groups within the segment, the administrator may conclude that none of the alternatives actions available in response to the events has a significant effect on the metric values within the segment.

FIG. 1b illustrates a second example computing environment 100b in which systems of the present disclosure may operate, according to one embodiment. As shown, the computing environment 100b includes a back-end system 160, a decision-making agent 170 executing in a private network 102b, and web server(s) 174 in the private network 102b. In one embodiment, back-end system 160 is a distributed cloud-computing system. The private network 102b may be an EPN, a LAN, a CAN, a VPN, or some other type of private network.

Server-side application 176 represents a software application executing on web server(s) 174 as part of an external-facing service. Server-side application 176 includes a thin client 177 for a programming language. The thin client 177 allows the server-side application 176 to communicate with the decision-making agent 170 in a language-agnostic manner. The thin client 177 includes code for reporting time-series event data and other usage data to the back-end system 160 via a private network connection 103b. While only one instance of the server-side application 176 and only one thin client 177 are shown in FIG. 1b, persons of skill in the art will understand that additional servers represented by web server(s) 174 may have versions of the thin client 177 for other languages, respectively.

For FIG. 1b, the explanations of time-series event data, consumers, decision-point event types, sessions, metric/goal definitions, optimization directions, orders of priorities, weight constructs, training instances, and machine-learning models, tradeoff relationships, and allocation of sessions to policies provided with respect to FIG. 1a apply. Furthermore, the descriptions of the back-end system 120, the persistent data repository 161, the sessions 162, the analytics database 123, the policy generator 124, the metrics tracker 125, the segment discovery component 126, the interface component 127, the metric/goal definitions 128, the control policy 111a, the optimized policy 111b, the in-memory database 112, the active sessions 113, the private network 102, the persistent database 118, the endpoint device(s) 180, the browser(s) 181, and the network connection 103 with respect to FIG. 1a apply to the back-end system 160, the persistent data repository 161, the sessions 162, the analytics database 163, the policy generator 164, the metrics tracker 165, the segment discovery component 166, the interface component 167, the metric/goal definitions 168, the control policy 171a, the optimized policy 171b, the in-memory database 172, the active sessions 173, the private network 102b, the persistent database 178, the endpoint device(s) 190, the browser(s) 191, and the network connection 103b, respectively.

However, in FIG. 1b, no monolithic clients are used. Thin clients are much simpler and easier to create than monolithic clients. Hence, thin clients for supporting particular programming languages can be created much more quickly and inexpensively than monolithic clients. In addition, since decision-making policies and sessions are stored in a decision-making agent, the thin clients are stateless. Furthermore, since thin clients allow decision making to occur at a decision-making agent, complex policies based on complex models can be applied at the decision-making agent. By contrast, policies stored at monolithic clients may be simplified or truncated to meet resource constraints (e.g., for processing or memory) of the endpoint devices on which the monolithic clients execute.

As explained above with respect to FIG. 1a, one advantage of storing the active sessions 173 in the in-memory database 172 is latency reduction, since the time-series data can be fetched relatively quickly from the in-memory database 172 without requiring communication outside of the private network 102b.

When a decision-point event is detected at the server-side application 176 (e.g., based on a communication received from the browser(s) 191 executing at the endpoint device(s) 190), the thin client 177 sends a decision-making request to the decision-making agent 170 via the network connection 103b. In one embodiment, the decision-making request is an API message that includes an identifier of a consumer logged in to the server-side application 176. The decision-making request also indicates the type of the decision-point event so that the type of decision being requested is clear. For example, for some types of decision-point events, the decision-making request may call for a list of items to recommend to the consumer selected from a larger group of candidate items. For other types of decision-point events, the decision-making request may call for a selection of a single content item to present to the consumer from a group of several candidate content items (e.g., background colors, font colors, font types, CSS files, an images, videos, toolbars, product descriptions, and slideshows). For other types of decision-point events, the decision-making request may call for a selection of some other type of action or list of actions to perform in response to the decision-point event.

The decision-making agent 170 includes an in-memory database 172. In one embodiment, the in-memory database 172 is fully or partially contained in random access memory (RAM) or a cache (although storage may be used in alternative embodiments). The in-memory database 172 stores the active sessions 173. In one embodiment, the term “active session” refers to a session in which the latest recorded event occurred less than a threshold amount of time ago. The active sessions 173 are a subset of the sessions 162, so the active sessions 173 are stored in both the persistent data repository 161 and the in-memory database 172. The persistent database 178 may also store copies of the active sessions 173 and/or other subsets of the sessions 162.

The decision-making agent 170 identifies a session (from the active sessions 173) that is associated with the consumer ID and retrieves the time-series data contained in the session from the in-memory database 172. One advantage of storing the active sessions 173 in the in-memory database 172 is latency reduction, since the time-series data can be fetched relatively quickly from the in-memory database 172 without requiring communication outside of the private network 102. If the session associated with the consumer ID is not found among the active sessions 173, the decision-making agent 170 may retrieve the time-series data contained in the session from the persistent database 178 that is connected to the decision-making agent 170 within the private network 102. In very rare cases, the time-series data may not be available in the active sessions 173 or in the persistent database 178. In such cases, the decision-making agent 170 may retrieve the time-series data contained in the session from the persistent data repository 161 via the network connection 101b.

Once the time-series data from the session associated with the consumer ID has been retrieved, the decision-making agent 170 determines whether to apply the control policy 171a or the optimized policy 171b. For example, the decision-making agent 170 may input the consumer ID (or another identifier for the session) into a hashing function that randomly assigns the applicable policy. If the control policy 171a is assigned, the decision-making agent 170 selects one or more actions for the server-side application 176 to perform based on the control policy 171a. If the optimized policy 171b is assigned, the decision-making agent 170 compares the time-series data and the type of the decision-point event to the optimized policy 171b. Based on the comparison, the decision-making agent 170 selects one or more actions for the server-side application 176 to perform in response to the decision-point event. For example, if the optimized policy 171b is represented via a function of features (e.g., the input features of training instances in the training set), the decision-making agent 170 calculates values for those features based on the time series data and evaluates the function using the values as input.

Next, the decision-making agent 170 sends a response message indicating the one or more selected actions to the thin client 177 via the network connection 103b. Upon receiving the response message via the thin client 177, the server-side application 176 performs the one or more selected actions and reports the performance to the decision-making agent 170 via the thin client 177.

The decision-making agent 170 updates the session for the consumer in the active sessions 173 to reflect the occurrence of the decision-point event and the performance of the selected actions. The decision-making agent 170 also signals the back-end system 160 to update the copy of the session found in the sessions 162.

FIG. 1c illustrates a third example computing environment 100c in which systems of the present disclosure may operate, according to one embodiment. As shown, the computing environment 100c includes a back-end system 140 and endpoint device(s) 150. In one embodiment, back-end system 140 is a distributed cloud-computing system. Endpoint device(s) 150 may represent any type of client endpoint device, such as a mobile phone, a laptop computer, a desktop computer, a tablet computer, or in IoT device. The back-end system 140 and the endpoint device(s) 150 may be connected through a network (e.g., the Internet or another WAN) represented by the network connection 101c.

Client-side application 155 executes on the endpoint device(s) 150. Monolithic client 151 includes code for reporting time-series event data and other usage data to the back-end system 140 via the network connection 101c. The monolithic client 151 allows the client-side application 155 to communicate with the back-end system 140 to report time-series data. While only one instance of the client-side application 155 and only one monolithic client 151 are shown in FIG. 1b, persons of skill in the art will understand that additional endpoint devices represented by endpoint device(s) 150 may have versions of the monolithic client 151 that are specific to the types of the additional endpoint devices, respectively.

In one embodiment, the monolithic client 151 can be a JavaScript file served off of a highly available content delivery network (CDN). In another embodiment, the monolithic client 151 is built into the client-side application 155 (e.g., if the endpoint device(s) 150 is a mobile device and the client-side application 155 is a native application for the mobile device).

For FIG. 1c, the explanations of time-series event data, consumers, decision-point event types, sessions, metric/goal definitions, optimization directions, orders of priorities, weight constructs, training instances, and machine-learning models, tradeoff relationships, and allocation of sessions to policies provided with respect to FIG. 1a apply. Furthermore, the descriptions of the back-end system 120, the persistent data repository 121, the sessions 122, the analytics database 123, the policy generator 124, the metrics tracker 125, the segment discovery component 126, the interface component 127, the metric/goal definitions 128, the control policy 132, the optimized policy 133, and the session 134 with respect to FIG. 1a apply to the back-end system 140, the persistent data repository 141, the sessions 142, the analytics database 143, the policy generator 144, the metrics tracker 145, the segment discovery component 146, the interface component 147, the metric/goal definitions 148, the control policy 152, the optimized policy 153, and the session 154, respectively.

However, in FIG. 1c, no decision-making agent is used. For this reason, once the policy generator 144 generates a decision-making policy, the policy generator 144 deploys the policy directly to the monolithic client 151 instead of a decision-making agent. The monolithic client 151 stores local copies of policies deployed by the policy generator 151. For this reason, the monolithic client 151 includes control policy 152 and optimized policy 153.

One advantage of storing policies locally on endpoint device(s) 150 is latency reduction for decision-making functionality. When a policy is applied to decision-point events on endpoint device(s) 150 locally, latency due to network communications (e.g., between the endpoint device(s) 150 and a decision-making agent) can be eliminated. However, processing speed, memory, and other hardware available on endpoint device(s) 150 may be relatively limited. Also, client-side programming languages (e.g., JavaScript) may not be well suited for implementing policies that tie up large amounts of memory. To address these issues, when the policy generator 144 generates a policy according to logic learned by the machine-learning model based on training data (e.g., as described with respect to policy generator 124 in FIG. 1a above), the policy generator 144 can represent the policy in a relatively small amount of space (e.g., one megabyte or less) in a client-side programming language. The policy may be a machine-learning model (e.g., a full or truncated model) or, in some embodiments, a set of rules mapping session states to one or more actions.

When a consumer logs in to the client-side application 155 on the endpoint device(s) 150, the monolithic client 151 records a description of the login event in the session 154. The session 154 is a locally stored session associated with the consumer. The monolithic client 151 may use local storage (e.g., cookies) to ensure session continuation within the TTL (e.g., if a time period between when the client-side application 155 is closed and re-opened is less than the TTL, the previous session is resumed).

When a decision-point is detected at the client-side application 155, the monolithic client 151 first determines whether to apply the control policy 152 or the optimized policy 153. For example, the monolithic client 151 may input the consumer ID (or another identifier for the session 154) into a hashing function that randomly assigns the applicable policy. If the control policy 152 is assigned, the monolithic client 151 selects one or more actions to perform based on the control policy 152. If the optimized policy 153 is assigned, the monolithic client 151 compares the time-series data in the session 154 and the type of the decision-point event to the optimized policy 153. Based on the comparison, the monolithic client 151 selects one or more actions to perform in response to the decision-point event. For example, if the optimized policy 153 is represented via a function of features (e.g., the input features of training instances in a training set), the monolithic client 151 calculates values for those features based on the time-series data and evaluates the function using the values as input.

Next, the monolithic client 151 performs the one or more selected actions and reports the performance to back-end system 140 via the network connection 101c. The back-end system 140 updates the session for the consumer in the sessions 142 to reflect the occurrence of the decision-point event and the performance of the selected actions.

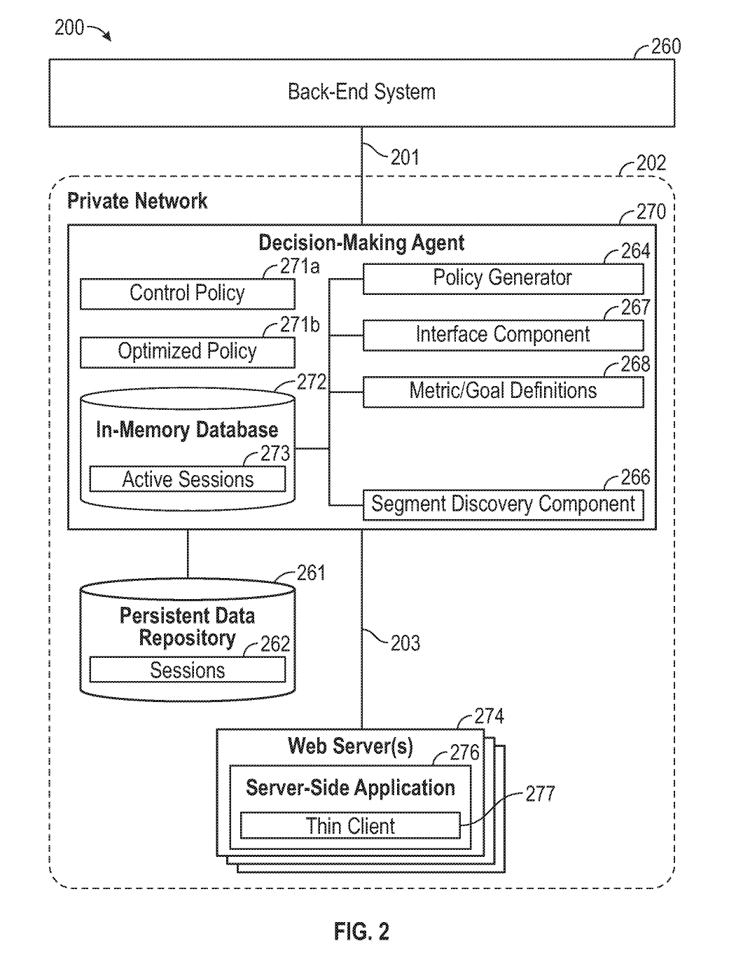

FIG. 2 illustrates a fourth example computing environment 200 in which systems of the present disclosure may operate, according to one embodiment. As shown, the computing environment 200 includes a back-end system 260, a decision-making agent 270 executing in a private network 202, and web server(s) 274 in the private network 202. In one embodiment, back-end system 260 is a distributed cloud-computing system. The private network 202 may be an EPN, a LAN, a CAN, a VPN, or some other type of private network.

For FIG. 2, the explanations of time-series event data, consumers, decision-point event types, sessions, metric/goal definitions, optimization directions, orders of priorities, weight constructs, training instances, and machine-learning models, tradeoff relationships, and allocation of sessions to policies provided with respect to FIG. 1a apply. Furthermore, the descriptions of the web server(s) 114, the server-side application 116, the thin client 117, the persistent data repository 161, the sessions 162, the policy generator 124, the segment discovery component 126, the interface component 127, the metric/goal definitions 128, the control policy 111a, the optimized policy 111b, the in-memory database 112, the active sessions 113, the private network 102, and the network connection 103 with respect to FIG. 1a apply to the web server(s) 274, the server-side application 276, the thin client 277, the persistent data repository 261, the sessions 262, the policy generator 264, the segment discovery component 266, the interface component 267, the metric/goal definitions 268, the control policy 271a, the optimized policy 271b, the in-memory database 272, the active sessions 273, the private network 202, and the network connection 203, respectively.

However, in the computing environment 200, the policy generator 264, the interface component 267, the metric/goal definitions 268, and the segment discovery component 266 are included in the decision-making agent 270 instead of the back-end system 260. Furthermore, the persistent data repository 261 is located in the private network 202 instead of the back-end system 260. Thus, the time-series data in the sessions 262 is stored entirely within the private network 202 and processed by the policy generator 264, the segment discovery component 266, and the interface component 267 without ever leaving the private network 202. For this reason, the computing environment 200 may be suitable for scenarios in which the time-series data is sensitive and should not be stored in an offsite cloud-computing infrastructure for security purposes. If the private network 202 owned by a medical care provider and the time-series data comprises confidential medical information, the medical care provider may wish to prevent any exfiltration of the time-series data from the private network 202.

When a decision-point event is detected at the server-side application 276, the thin client 277 sends a decision-making request to the decision-making agent 270 via the network connection 203. In one embodiment, the decision-making request is an API message that includes an identifier of a consumer logged in to the server-side application 276. The decision-making request also indicates the type of the decision-point event so that the type of decision being requested is clear. For example, for some types of decision-point events, the decision-making request may call for a list of items to recommend to the consumer selected from a larger group of candidate items. For other types of decision-point events, the decision-making request may call for a selection of a single content item to present to the consumer from a group of several candidate content items (e.g., background colors, font colors, font types, CSS files, an images, videos, toolbars, product descriptions, and slideshows). For other types of decision-point events, the decision-making request may call for a selection of some other type of action or list of actions to perform in response to the decision-point event.

The decision-making agent 270 includes an in-memory database 272. In one embodiment, the in-memory database 272 is fully or partially contained in random access memory (RAM) or a cache (although storage may be used in alternative embodiments). The in-memory database 272 stores the active sessions 273. In one embodiment, the term “active session” refers to a session in which the latest recorded event occurred less than a threshold amount of time ago. The active sessions 273 are a subset of the sessions 262, so the active sessions 273 are stored in both the persistent data repository 261 and the in-memory database 272.

The decision-making agent 270 identifies a session (from the active sessions 273) that is associated with the consumer ID and retrieves the time-series data contained in the session from the in-memory database 272. One advantage of storing the active sessions 273 in the in-memory database 272 is latency reduction, since the time-series data can be fetched relatively quickly from the in-memory database 272. If the session associated with the consumer ID is not found among the active sessions 273, the decision-making agent 270 may retrieve the time-series data contained in the session from the sessions 262 in the persistent data repository 261.

Once the time-series data from the session associated with the consumer ID has been retrieved, the decision-making agent 270 determines whether to apply the control policy 271a or the optimized policy 271b. For example, the decision-making agent 270 may input the consumer ID (or another identifier for the session) into a hashing function that randomly assigns the applicable policy. If the control policy 271a is assigned, the decision-making agent 270 selects one or more actions for the server-side application 276 to perform based on the control policy 271a. If the optimized policy 271b is assigned, the decision-making agent 270 compares the time-series data and the type of the decision-point event to the optimized policy 271b. Based on the comparison, the decision-making agent 270 selects one or more actions for the server-side application 276 to perform in response to the decision-point event. For example, if the optimized policy 271b is represented via a function of features (e.g., the input features of training instances in the training set), the decision-making agent 270 calculates values for those features based on the time series data and evaluates the function using the values as input.

Next, the decision-making agent 270 sends a response message indicating the one or more selected actions to the thin client 277 via the network connection 203. Upon receiving the response message via the thin client 277, the server-side application 276 performs the one or more selected actions and reports the performance to the decision-making agent 270 via the thin client 277.

The decision-making agent 270 updates the session for the consumer in the active sessions 273 to reflect the occurrence of the decision-point event and the performance of the selected actions. The decision-making agent 270 also signals the persistent data repository 261 to update the copy of the session found in the sessions 262.

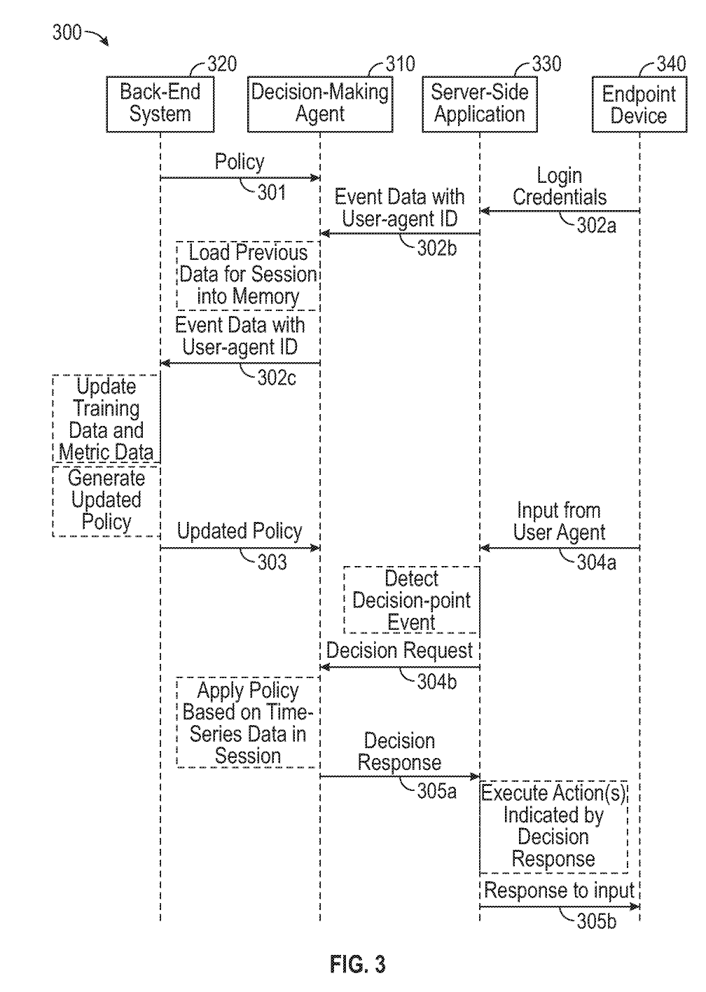

FIG. 3 illustrates an example signal diagram 300 for communications between a back-end system 320, a decision-making agent 310, a server-side application 330, and an endpoint device 340, according to one embodiment. The signal diagram 200 is provided for illustrative purposes only. In some embodiments, the order of the communications depicted in the signal diagram may be changed, and some communications may be combined, omitted, or exchanged between a different pair of elements. Furthermore, in some embodiments, some elements may be omitted entirely.

At arrow 301, when a decision-making policy (e.g., such as the optimized policy 111b) is generated, the back-end system 320 sends a copy of the policy to the decision-making agent 310.

At arrow 302a, when a consumer logs in to the server-side application 330 via the endpoint device 340 (e.g., through a browser), the endpoint device 340 sends login credentials for the consumer to the server-side application 330. The server-side application 330 authenticates the consumer using the login credentials. The server-side application 330 may include a thin client for processing communications received in a programming language used at the endpoint device 340. Once the consumer has been authenticated, there are two different types of sessions associated with the user. One may be a Hypertext Markup Language (HTML) session kept at the server-side application 330 that has a predefined Time To Live (TTL). If the consumer previously logged out of the server-side application 330 within the TTL after a previous login, the server-side application 330 may continue an previous HTML session that was active at the time of the previous logout. However, if the TTL has expired, the server-side application 330 may create a new HTML session. However, a session associated with the consumer at the decision-making agent 310 may not expire,

At arrow 302b, the server-side application 330 sends event data to the decision-making agent 310. The event data sent at arrow 302b includes an identifier of the consumer (i.e., the consumer ID) and a timestamp indicating when the login event occurred. Upon receiving the event data, the decision-making agent 310 identifies a session associated with the consumer ID and verifies that any previous time-series data stored in the session is loaded into memory along with the event data. By loading the previous time-series data into memory, the decision-making agent 310 ensures that previous time-series data in the session will be rapidly available for comparison to the decision-making policy when decision-point requests are received from the server-side application 330.

At arrow 302c, the decision-making agent 310 forwards the event data and the consumer ID to the back-end system 320. The back-end system 320 stores the event data in a copy of the session that is stored in a persistent data repository. In addition, the back-end system 320 updates metric values for the session to reflect the event data. Also, the back-end system 320 updates a set of training data to reflect the event data, trains a machine-learning model using the updated training data, and generates an updated decision-making policy based on the machine-learning model and a goal definition.

At arrow 303, the back-end system deploys the updated policy to the decision-making agent 310. At arrow 304a, while the consumer interacts with the server-side application 330 via the endpoint device 340, the endpoint device 340 sends a communication that includes input from the consumer for the server-side application 330.

The decision-making request includes the consumer identifier and indicates a type of the decision-point event. The server-side application 330 uses the language wrapper to format the decision-making request in a manner that can be interpreted by the decision-making agent 310. Based on the input, the server-side application 330 detects that a particular type of decision-point event has occurred.

At arrow 304b, the server-side application 330 sends a decision-making request to the decision-making agent 310 (either directly or from a replay queue). The decision-making agent 310 may first determine whether a decision-making request for the same type of decision-point event has previously occurred within a threshold amount of time (e.g., by checking the time-series data in a session associated with the consumer for decision-point events of the same type). This threshold amount of time serves as a Time To Live (TTL) for the decision that was made in response to the previous decision-point event. If the same type of decision-point event did previously occur within the decision TTL, the decision-making agent 310 selects the same actions that were performed in response to the previous decision-point event of the same type to ensure a consistent experience for the consumer. Otherwise, the decision-making agent 310 selects one or more actions for the endpoint device 340 to perform by comparing the time-series data in the session container and the type of the decision-making event to the updated policy. The actions are selected from a predefined group of actions.

At arrow 305a, the decision-making agent 310 sends a response indicating the one or more actions to the server-side application 330. The server-side application 330 executes some or all of the one or more actions.

At arrow 305b, the server-side application 330 sends a response to input from the consumer to the endpoint device 340. The endpoint device 340 executes any remaining portions of the one or more actions that were not completed by the server-side application 330.

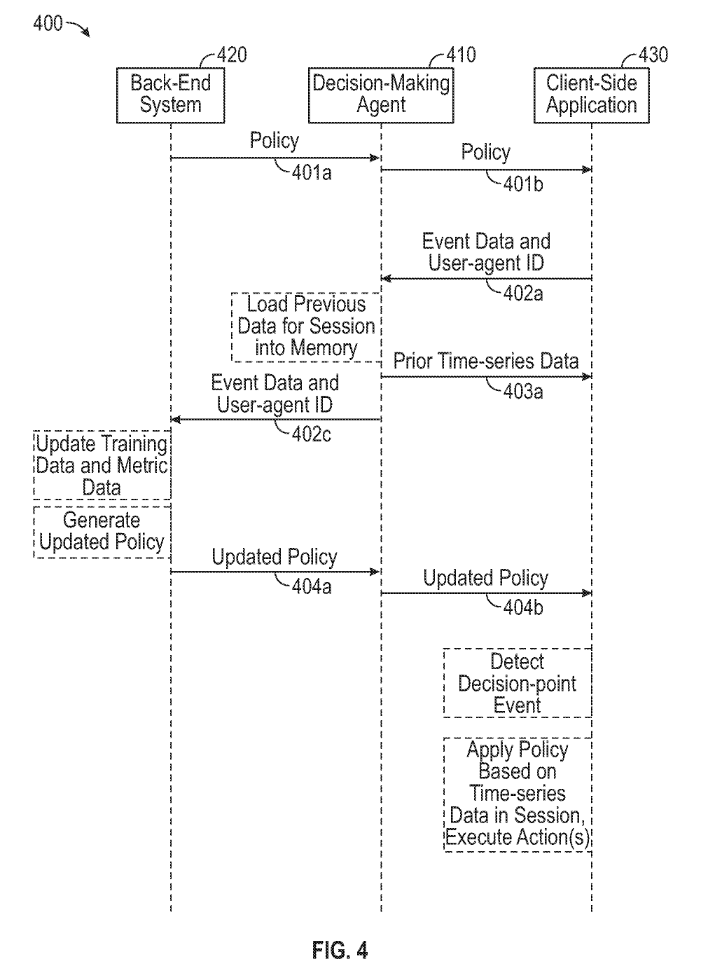

FIG. 4 illustrates an example signal diagram 400 for communications between a back-end system 420, a decision-making agent 410, and a client-side application 430, according to one embodiment.

At arrow 401a, when a decision-making policy is generated, the back-end system 420 sends a copy of the policy to the decision-making agent 410. At arrow 401b, the decision-making agent 410 sends the policy to the client-side application 430.

At arrow 402a, when a consumer logs in to the client-side application 430 at an endpoint device, the client-side application 430 sends event data describing the login event to the decision-making agent 410. The event data sent at arrow 402a includes an identifier of the consumer (i.e., the consumer ID) and a timestamp indicating when the login event occurred. The client-side application 430 includes a monolithic client for communicating with the decision-making agent 410.

Upon receiving the event data, the decision-making agent 410 identifies a session associated with the consumer ID and verifies that any previous time-series data stored in the session is loaded into memory along with the event data.

At arrow 403a, the decision-making agent 410 sends the previous time-series data to the client-side application 430. The client-side application 430 stores the prior time-series data in memory along with the event data in a local copy of the session so that the data in the session will be rapidly available at the client-side application 430 for comparison to the policy when decision-point events are detected.

At arrow 402c, the decision-making agent 410 forwards the event data and the consumer ID to the back-end system 420. The back-end system 420 stores the event data in a copy of the session that is stored in a persistent data repository. In addition, the back-end system 420 updates metric values for the session to reflect the event data. Also, the back-end system 420 updates a set of training data to reflect the event data, trains a machine-learning model using the updated training data, and generates an updated decision-making policy based on the machine-learning model and a current goal definition.

At arrow 404a, the back-end system 420 sends the updated policy to the decision-making agent 410. At arrow 404b, the decision-making agent 410 forwards the updated policy to the client-side application 430.

When a decision-point event is detected at the client-side application 430, the monolithic client selects one or more actions for the client-side application 430 to perform by comparing the time-series data in the session and the type of the decision-making event to the updated policy. The actions are selected from a predefined group of actions. The client-side application 430 executes the one or more actions at the endpoint device.

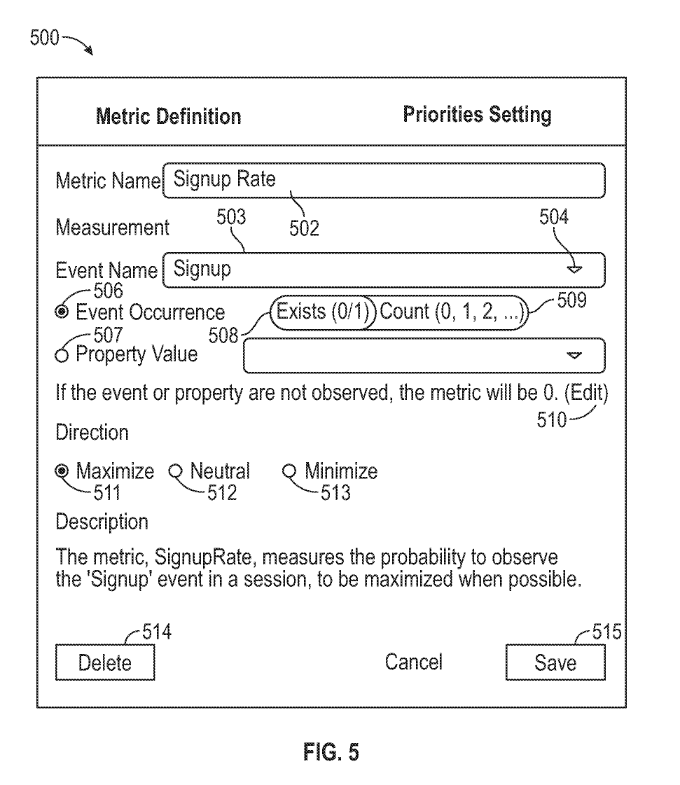

FIG. 5 illustrates an example interface 500 through which an administrator may provide a metric definition and an optimization direction for a metric, according to one embodiment. While interface 500 is provided as an illustrative example, persons of skill in the art will recognize that interfaces with different fields, formats, labels, and other characteristics may be used without departing from the spirit and scope of the disclosure. As a practical matter, any graphical or command-line interface that allows an administrator to specify a name for a metric, a way in which the metric is calculated, and an optimization direction for the metric can be used in embodiments described herein.

In field 502, the administrator can enter a name for a metric that is currently being defined. In this example, as shown, this metric is named “Signup Rate.”

Under the heading “Measurement,” the administrator can specify one or more event types of which the metric is a function in field 503, which is labeled “Event Name.” Specifically, the administrator may click on arrow 504 to reveal a drop-down list of selectable events, properties, and other data that can be gathered during interactions between a consumer and software application. In this example, an event entitled “Signup” is selected (e.g., an event in which a consumer signed up for a particular service offered via the software application or created an account with the software application). If a property is selected rather than an event in field 503, the label “Event Name” may be dynamically changed to “Property Name.”

In addition, under the heading “measurement,” radio button 506 and radio button 507 allow the administrator to specify a scheme for representing values of the metric that is currently being defined (e.g., a binary scheme or a count scheme). For example, if the tab 508 is selected, the value of the metric may be represented by the number one for sessions in which at least one “signup” event is recorded and represented by the number zero otherwise. Optionally, the administrator can set a default value of the metric (e.g., for sessions in which the event or property is unseen or undefined) by clicking on the word “edit” in parentheses 510. If the tab 509 is selected, the value of the metric may be represented by a count of the number of times an event selected in field 503 has occurred as recorded in a in a session container.

In another example, if radio button 507 were selected instead of radio button 506, the administrator could select a scheme for representing values of a property selected in field 503. Depending on the nature of the property selected and the granularity desired for measurements, there are many possible schemes that could be used. For example, if the property is the amount of time since a consumer last logged in to the software application, the time property may be represented by a number of minutes, seconds, or milliseconds (e.g., as a real number or an integer).

Under the heading “Direction,” the administrator can specify an optimization direction for values of the metric. The optimization direction indicates whether the administrator wishes for a policy to increase (e.g., like a bowling score) or decrease (e.g., like a golf score) values of the metric on the average. This makes it possible for there to be meaningful comparisons between different values of the metric such that one value can be unambiguously identified as more fulfilling of the administrator's objectives than another. In this example, since radio button 511 is selected, the direction of optimization for the “Signup Rate” is upward (meaning that the administrator wants a policy to increase the value of the signup rate on the average). In another example, if radio button 513 were selected, the direction of optimization would be downward. In another example, the administrator may select radio button 512 to indicate that the administrator wishes to track values of the metric, but that the administrator does not wish for the policy to be tuned for increasing or decreasing values of the metric on the average.

Also, the administrator may enter a plain-language textual description of the goal metric under the heading “Description” for the administrator's reference. The user can delete the current metric definition by clicking on button 514 or save the current metric definition by clicking on button 515.

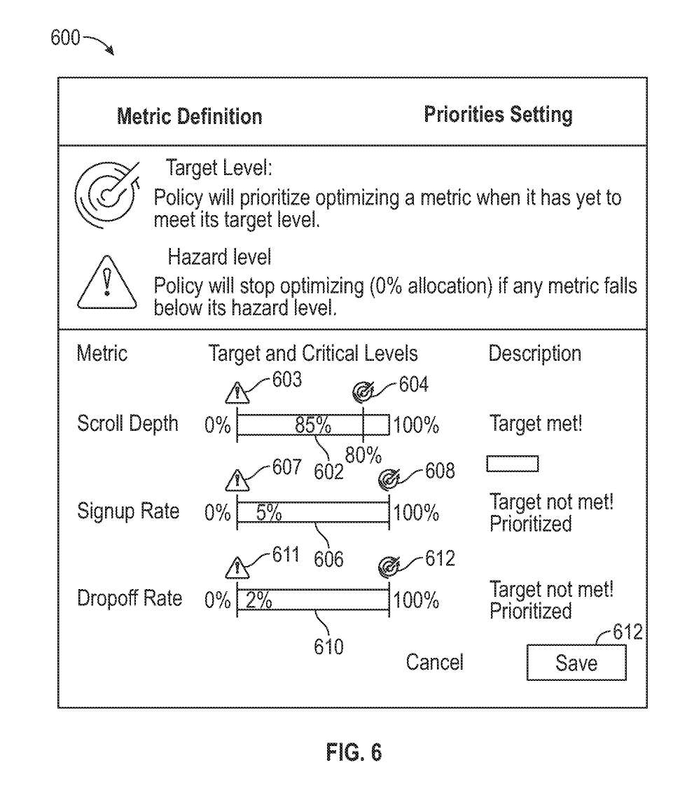

FIG. 6 illustrates an example interface 600 through which an administrator may specify hazard conditions and target conditions for metrics that are parameters of a goal definition, according to one embodiment. While interface 600 is provided as an illustrative example, persons of skill in the art will recognize that interfaces with different fields, formats, labels, and other characteristics may be used without departing from the spirit and scope of the disclosure. As a practical matter, any graphical or command-line interface that allows an administrator to specify hazard conditions and target conditions for metrics can be used in embodiments described herein.

The goal definition referenced by interface 600 includes three metrics as parameters: scroll depth, signup rate, and dropoff rate. In other examples, other numbers of metrics may be included as parameters in a goal definition. Representation schemes, optimization directions, and event parameters for each of the metrics in the goal set may be defined by the administrator (e.g., in an interface similar to interface 500) beforehand.

The administrator can slide icon 604 across slider 602 to indicate a target level for the scroll depth metric. As shown, the target level is currently set to 80%. Similarly, the administrator can slide icon 603 across slider 602 to indicate a hazard condition for the scroll depth metric. As shown, the hazard level is currently set to 0%. If the optimization direction for scroll depth is upward, the target condition for scroll depth is that the value of scroll depth be at 80% or higher, while the hazard condition for scroll depth is that is that the value of scroll depth be at 0% or higher.

The administrator can slide icon 608 across slider 606 to indicate a target level for the signup rate metric. As shown, the target level is currently set to 100%. Similarly, the administrator can slide icon 607 across slider 606 to indicate a hazard level for the signup rate metric. As shown, the hazard level is currently set to 0%. If the optimization direction for signup rate is upward, the target condition for signup rate is that the value of signup rate be at 100% or higher, while the hazard condition for signup rate is that is that the value of signup rate be at 0% or higher.

Note that percentages may not be suitable ways to specify target conditions or hazard conditions for some metrics. For metrics that have no definite maximum (e.g., revenue), target conditions and hazard conditions may be defined in terms of an actual value (e.g., such as a dollar amount for revenue) instead of a percentage.

The administrator can slide icon 612 across slider 610 to indicate a target level for the dropoff rate metric. As shown, the target level is currently set to 100%. Similarly, the administrator can slide icon 611 across slider 610 to indicate a hazard level for the scroll depth metric. As shown, the hazard level is currently set to 0%. If the optimization direction for dropoff rate is downward, the target condition for dropoff rate is that the value of dropoff rate be at 100% or lower, while the hazard condition for dropoff rate is that is that the value of dropoff rate be at 0% or lower. If the administrator clicks on the save button while icon 611 and icon 612 are in the positions shown, an error message can be displayed. The error message can explain that the current positions of icon 611 and icon 612 suggest that the target condition can be satisfied without the hazard condition also being satisfied.

FIG. 7 illustrates an example interface 700 through which an administrator may view how a software application is performing with respect to the metrics referenced in a goal definition, according to one embodiment. The sidebar 702 has a selectable list of the metrics. In example, the metrics referenced by the goal definition include scroll depth, signup rate, and dropoff rate. The outline box 704 indicates that the signup rate goal metric is selected.

Since the signup rate goal metric is selected, the line graph 706 illustrates the average signup rates for sessions that started during a selected week (e.g., the week beginning on June 8, as shown). The administrator can select the period of time by clicking on arrow 715 to reveal a drop-down list of selectable time periods for which data is available. Curve 707 tracks average daily signup rates for sessions in which an optimized policy was applied for selecting actions to perform in response to decision-point events. In this example, each day in the selected week serves as the time interval corresponding to a bin. The administrator can select the policy by clicking on arrow 716 to reveal a drop-down list of selectable policies for which data is available. The administrator can also select a decision-point event type by clicking on arrow 717 to reveal a drop-down list of selectable decision-point event types. In this way, the administrator can view the average signup rates and other statistics for the subset of sessions in which a specific type of decision-point event was recorded and exclude sessions in which that type of decision-point event did not occur. Curve 708 tracks average signup rates for a sessions in which a control policy was applied instead of the optimized policy. Line 709 depicts the average signup rate for sessions that started during the selected week (i.e., the overall average) for the sessions in which the control policy was applied.

Sessions are grouped into the bins according to the sessions' starting times. Hence, sessions that started on June 8^{th} are grouped into the bin labeled June 8, sessions that started on June 9^{th} are grouped into the bin labeled June 9, and so on. However, sessions are not required to have definite ending times, so the duration of a session is unconstrained by the duration of the bin to which the session is assigned. Since metric values for sessions are calculated based on all the data in the sessions, the metric values may reflect events even data describing events that occur after the ending times of the bins into which the sessions are grouped. In this example, the signup rates attributed to the “June 8” bin by curve 707 and curve 708 may reflect signups that occurred after June 8, after June 14, or even later. Thus, curve 707, curve 708, and line 709 may change each time new time-series data becomes available even though the time intervals corresponding to the bins remain unchanged. Since the time intervals corresponding to the bins and the start times of the sessions do not change, the particular sessions grouped into each bin remain consistent regardless of how many times curve 707, curve 708, and line 709 are updated. Optionally, the interface may also save the states of curve 707, curve 708, and line 709 after each update and allow an administrator to view the different states in succession as an animation. Upon viewing the animation, an administrator may be able to detect delayed trends in the time-series data.

Interface 700 also includes a selectable list 710 of segments (under the heading “By Segment”). The “Saved Segmentation” group refers to segments that the administrator has previously designated as being of interest. For example, suppose the administrator wants to see how the average signup rate for patrons who use desktop devices in a certain geographical region compares to the overall average signup rate. The administrator can manually define the segment beforehand and save the definition so that the interface 700 will determine the average signup rate for the segment automatically along with the average signup rates for a given time period.

In this example, the box 711 indicates the “DiscoveredA1” segment is selected rather than the “Saved Segmentation” group. The “DiscoveredA1” group refers to segments that a segment discovery component has determined to have average signup rates that vary from the overall average signup rate by more than a threshold amount (e.g., 5% or another predefined amount to avoid false positives due to sampling error). For example, row 713 of the table 712 shows the average signup rate for sessions in which a mobile device was used during the daytime was 69% higher than the overall average. In addition, row 614 of the table 612 shows the average signup rates for sessions in which a desktop device running a Windows operating system at night was used was 29% lower than the overall average.

To facilitate a clear explanation of how the segment discovery component may intelligently search through the space of possible segments to discover segments with average signup rates that vary from the overall average by more than a threshold amount, one example of how segments may be defined is provided below.

First, consider a simple case in which a segment is defined as all sessions in which a feature has a particular value (or disjunction of particular values). Suppose the first feature represents device type for a user device used during a session and that there are three possible values for device type: “mobile,” “tablet,” and “desktop.” In a set of sessions for which the value of the device type is known, there are six possible segments (i.e., subsets) of sessions that can be defined by filters against the value of the first feature: (1) first feature=“mobile,” (2) first feature=“tablet,” (3) first feature=“desktop,” (4) first feature=“mobile” or “desktop,” (5) first feature=“mobile” or “tablet,” and (6) first feature=“tablet” or “desktop.”

Next, suppose a second feature is considered. Suppose the second feature represents whether a session occurred during the day or the night and that there are two possible values for the second feature: “day” and “night.” There are two possible segments that can be defined by filters against the value of the second feature: (1) second feature=“day” and (2) second feature=“night.” If the first and second feature are both considered, twelve additional segments can be defined by conjunctive combinations of constraints on the first feature and the second feature: (1) first feature=“mobile” and second feature=“day”; (2) first feature=“mobile” and second feature=“night”; (3) first feature=“tablet” and second feature=“day”; (4) first feature=“tablet” and second feature=“night”; (5) first feature=“desktop” and second feature=“day”; (6) first feature=“desktop” and second feature=“night”; (7) first feature=“mobile” or “desktop,” and second feature=“day”; (8) first feature=“mobile” or “desktop,” and second feature=“night”; (9) first feature=“mobile” or “tablet,” and second feature=“day”; (10) first feature=“mobile” or “tablet,” and second feature=“night”; (11) first feature=“tablet” or “desktop,” and second feature=“day”; and (12) first feature=“tablet” or “desktop,” and second feature=“night.” Furthermore, twelve additional segments can be defined by disjunctive combinations of constraints on the first feature and the second feature: (1) first feature=“mobile” or second feature=“day”; (2) first feature=“mobile” or second feature=“night”; (3) first feature=“tablet” or second feature=“day”; (4) first feature=“tablet” or second feature=“night”; (5) first feature=“desktop” or second feature=“day”; (6) first feature=“desktop” or second feature=“night”; (7) first feature=“mobile” or “desktop,” or second feature=“day”; (8) first feature=“mobile” or “desktop,” or second feature=“night”; (9) first feature=“mobile” or “tablet,” or second feature=“day”; (10) first feature=“mobile” or “tablet,” or second feature=“night”; (11) first feature=“tablet” or “desktop,” or second feature=“day”; and (12) first feature=“tablet” or “desktop,” or second feature=“night.”

For each additional feature considered, the number of segments that can be defined increases exponentially. As a result, if there are many features and many possible values for each feature, it may be impractical to search check all possible segments to identify segments that have averages that deviate from an overall average for a metric by a predefined amount. Therefore, a segment discovery component may use a heuristic approach to search for segments of interest.

In one example, as a first step for identifying which segments to analyze, the segment discovery component may apply one or more feature-selection techniques to rank the features according to how strongly the contextual features correlate with a metric referenced by a goal definition. Some feature-selection techniques that can be applied include the Las Vegas Filter (LVF), Las Vegas Incremental (LVI) Relief, Sequential Forward Generation (SFG), Sequential Backward Generation (SBG), Sequential Floating Forward Search (SFFS), Focus, Branch and Bound (B & B), and Quick Branch and Bound (QB&B) techniques. The top n features (where n is a predefined positive integer) that are most strongly correlated with a metric can identified based on the output of the one or more feature-selection techniques for a set of training data (e.g., labeled training instances representing previous sessions).

Next, the segment discovery component may exclude segments that do not include any filters against the values of the top n features from analysis and calculate average goal scores (or other descriptive values) only for segments that include constraints on at least j of the top n features (where j is a predefined positive integer less than or equal to n). An administrator may specify the values of j and n beforehand or the segment discovery component may determine the values of j and n in a manner that ensures no more than a predefined number of segments will be analyzed. In this manner, the segment discovery component can reduce the number of segments for analysis to a level that is more tractable.

In some embodiments, the segment discovery component may also search for tradeoff relationships between contextual features and notify the administrator of those tradeoff relationships via the interface 700. For example, the segment discovery component may determine the correlation coefficients between each pair of features. The segment discovery component may inform the administrator about any pair of features for which the magnitude of the correlation coefficient exceeds a predefined threshold.

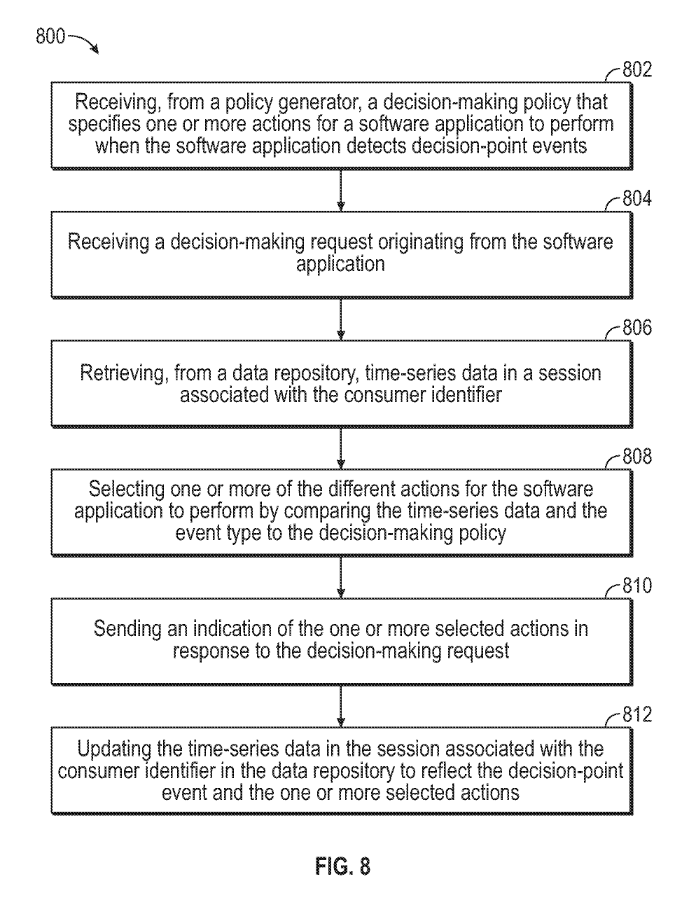

FIG. 8 illustrates a process 800 for a decision-making agent to integrate active decision-making functionality into a computing analytics framework, according to one embodiment. The process 800 can be implemented as a method or the process 800 can be executed as instructions on a machine (e.g., by one or more processors), where the instructions are included on at least one non-transitory computer-readable storage medium.

As shown in block 802, the process 800 includes receiving, from a policy generator, a decision-making policy that specifies one or more actions for a software application to perform when the software application detects decision-point events. The policy maps decision-point events of a same decision-point event type to different actions based on time-series data in sessions associated with consumers that interact with the software application. The time-series data in the session container may include timestamps and event descriptions for events that occurred on a plurality of devices through which a consumer specified by the consumer identifier has previously accessed the software application.

As shown in block 804, the process 800 includes receiving a decision-making request originating from the software application. The decision-making request includes a consumer identifier and indicates the decision-point event type. The request may be received from a thin client included in the software application. Also, in some embodiments, the request may be received through a private network connection between the decision-making agent and the software application.

The decision-making request may include a number indicating how many actions to select. Selecting one or more of the different actions for the software application to perform and sending an indication of the one or more selected actions may comprise: generating an ordered list of a subset of the different actions. The cardinality of the subset matches the number;

As shown in block 806, the process 800 includes retrieving, from a data repository, time-series data in a session associated with the consumer identifier. The data repository may be contained in Random Access Memory (RAM) memory, a cache, or a combination of the RAM and the cache.

As shown in block 808, the process 800 includes selecting one or more of the different actions for the software application to perform by comparing the time-series data and the event type to the decision-making policy.

As shown in block 810, the process 800 includes sending an indication of the one or more selected actions in response to the decision-making request.

As shown in block 812, the process 800 includes updating the time-series data in the session associated with the consumer identifier in the data repository to reflect the decision-point event and the one or more selected actions.

The process 800 may also include sending the updated time-series data to a persistent data store that is accessible to the policy generator; and receiving an updated policy from the policy generator. The updated policy may be based on the updated time-series data.

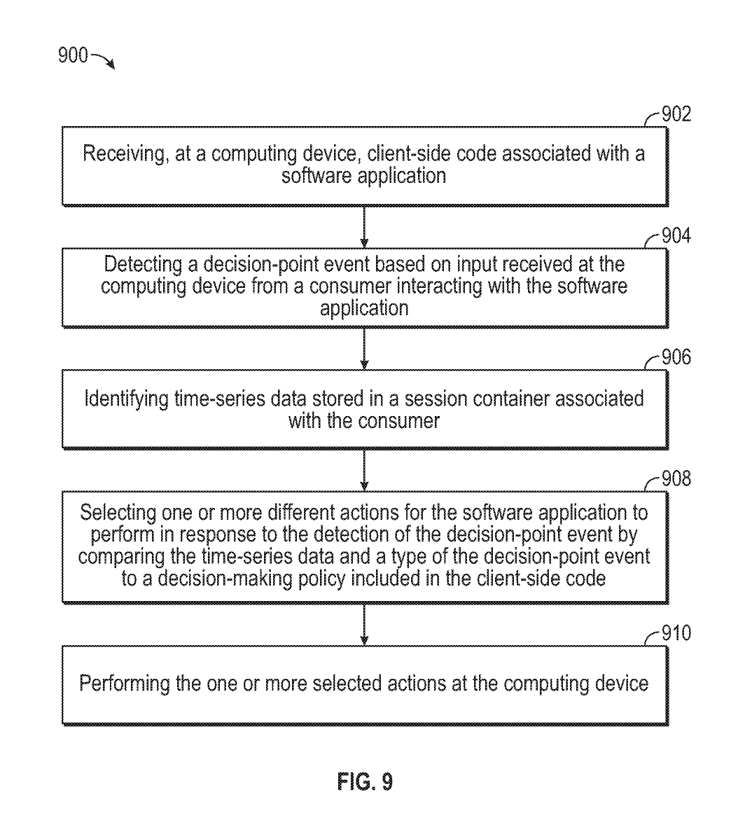

FIG. 9 illustrates a process 900 for a monolithic client to integrate active decision-making functionality into a computing analytics framework, according to one embodiment. The process 900 can be implemented as a method or the process 900 can be executed as instructions on a machine (e.g., by one or more processors), where the instructions are included on at least one non-transitory computer-readable storage medium.

As shown in block 902, the process 900 includes receiving, at a computing device, client-side code associated with a software application.

As shown in block 904, the process 900 includes detecting a decision-point event based on input received at the computing device from a consumer interacting with the software application.

As shown in block 906, the process 900 includes identifying time-series data stored in a session container associated with the consumer. Identifying the time-series data may comprise sending a request for a remotely stored portion of the time-series data associated with the consumer to a decision-making agent. Identifying the time-series data may also comprise: receiving the remotely stored portion of the time-series data via the network in response to the request; and adding the remotely stored portion of the time-series data to a locally stored portion of the time-series data. The remotely stored portion of the time-series data may include descriptions of events that occurred on one or more additional computing devices. Identifying the time-series data may also comprise: determining that a network connection to the remote network location is unavailable; and proceeding with the selecting by comparing a locally stored portion of the time-series data and the type of the decision-point event to the decision-making policy.

The process 900 may also include determining that a predefined amount of time has passed since the request was sent and that no response to the request has been received; and proceeding with the selecting by comparing a locally stored portion of the time-series data and the type of the decision-point event to the decision-making policy.

As shown in block 908, the process 900 includes selecting one or more different actions for the software application to perform in response to the detection of the decision-point event by comparing the time-series data and a type of the decision-point event to a decision-making policy included in the client-side code.

As shown in block 910, the process 900 includes performing the one or more selected actions at the computing device.

The process 900 may also include updating the time-series data to reflect the performance of the one or more selected actions; and sending the updated time-series data to a remote network location via a network for storage in a remote data repository.

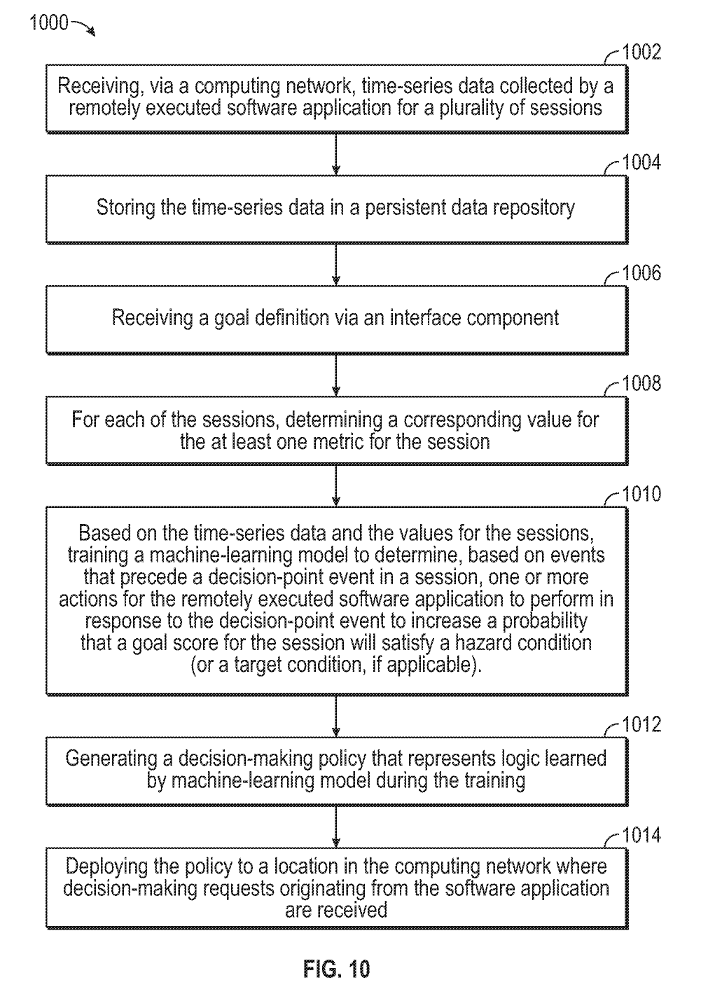

FIG. 10 illustrates a process 1000 for a policy generator, according to one embodiment. The process 1000 can be implemented as a method or the process 1000 can be executed as instructions on a machine (e.g., by one or more processors), where the instructions are included on at least one non-transitory computer-readable storage medium.

As shown in block 1002, the process 1000 includes receiving, via a computing network, time-series data collected by a remotely executed software application for a plurality of sessions. Each session is associated with a respective consumer.

As shown in block 1004, the process 1000 includes storing the time-series data in a persistent data repository.

As shown in block 1006, the process 1000 includes receiving a goal definition via an interface component. The goal definition specifies how to calculate a goal score based on at least one metric that is calculable based on the time-series data.

As shown in block 1008, the process 1000 includes: for each of the sessions, determining a corresponding value for the at least one metric for the session.

As shown in block 1010, the process 1000 includes: based on the time-series data and the values for the sessions, training a machine-learning model to determine, based on events that precede a decision-point event in a session, one or more actions for the remotely executed software application to perform in response to the decision-point event to increase a probability that a goal score for the session will satisfy a hazard condition (or a target condition, if applicable). The goal definition may also include a target condition for the at least one metric.

As shown in block 1012, the process 1000 includes generating a decision-making policy that represents logic learned by machine-learning model during the training. In one example, generating the decision-making policy may comprise encoding the logic in a client-side programming language and into no more than one megabyte (MB) of storage space.

As shown in block 1014, the process 1000 includes deploying the policy to a location in the computing network where decision-making requests originating from the software application are received. Deploying the policy may comprise sending the policy to a remote computing device on which the software application executes to enable the policy to be applied locally at the remote computing device.

If the computing network is a private network, the process 1000 may also include: receiving, from a remote computing device via the computing network, a decision-making request that includes a consumer identifier and indicates a decision-point event type; retrieving, from the data repository, a collection of time-series data in a session associated with the consumer identifier; selecting an action for the software application to perform by comparing the collection of time-series data and the event type to the decision-making policy; and sending an indication of the selected action in response to the decision-making request. The collection of time-series data in the session associated with the consumer identifier may include descriptions of previous decision-point events of the event type and corresponding timestamps.

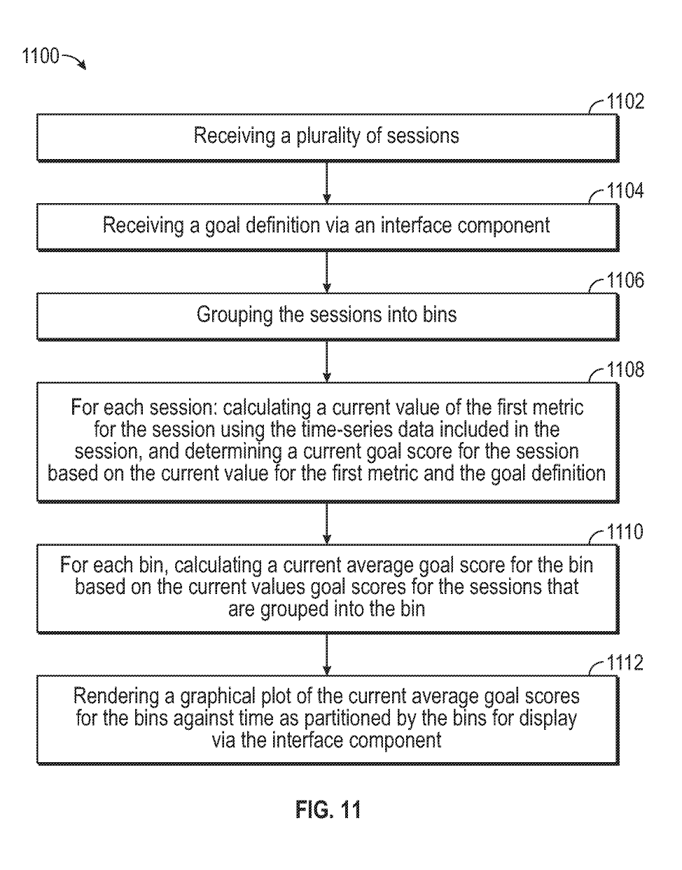

FIG. 11 illustrates a process 1100 for an interface component, according to one embodiment. The process 1100 can be implemented as a method or the process 1100 can be executed as instructions on a machine (e.g., by one or more processors), where the instructions are included on at least one non-transitory computer-readable storage medium.

As shown in block 1102, the process 1100 includes receiving a plurality of sessions. Each session is associated with a consumer, has a starting time, and includes time-series data characterizing interactions between the consumer and a software application executed at one or more remote computing devices.

As shown in block 1104, the process 1100 includes receiving a goal definition via an interface component. The goal definition specifies how to calculate a goal score based on at least one metric that is calculable based on the time-series data.

As shown in block 1106, the process 1100 includes grouping the sessions into bins. Each bin corresponds to a time interval and includes sessions that have starting times within the time interval.

As shown in block 1108, the process 1100 includes, for each session: calculating a current value of the first metric for the session using the time-series data included in the session, and determining a current goal score for the session based on the current value for the first metric and the goal definition. At least a portion of the time-series data used to calculate the current value of the first metric describes events that occurred outside of a time interval corresponding to a bin into which the session is grouped.

The goal definition may specify a function of the first metric and a second metric. Also, the process 1100 may include, for each session: calculating a current value of the second metric for the session using the time-series data included in the session, wherein at least a portion of the time-series data used to calculate the current value of the second metric describes events that occurred outside of the time interval corresponding to the bin into which the session is grouped, and determining the current goal score for the session by using the current value for the first metric as a first argument for the function and the current value for the second metric as a second argument for the function.

Receiving the goal definition may comprise receiving one or more of: a hazard condition for the first metric or the second metric; a target condition for the first metric or the second metric; a ranking for the first metric and the second metric; or a weight for the second metric or the first metric.

Receiving the goal definition may also comprise receiving a first optimization direction for the first metric and a second optimization direction for the second metric.

As shown in block 1110, the process 1100 includes: for each bin, calculating a current average goal score for the bin based on the current values goal scores for the sessions that are grouped into the bin.

As shown in block 1112, the process 1100 includes rendering a graphical plot of the current average goal scores for the bins against time as partitioned by the bins for display via the interface component.

The process 1100 may also include: calculating an overall average goal score across the bins based on the current goal scores for the sessions and grouping the session into a plurality of segments. Each segment comprises at least one filter against a feature that is calculable based on the time-series data. The process 1100 may also include, for each segment: determining a current average goal score for the segment based on the current goal scores for the sessions included in the segment, determining a difference between the current average goal score for the segment and the overall average goal score, and determining whether the difference exceeds a threshold. Furthermore, the process 1100 may include: for at least one segment for which the difference exceeds the threshold, rendering an indication of the segment and the difference for display via the interface component.

Each of the sessions may include at least one decision-point event of a selected type. The process 1100 may also include: receiving, from a policy generator, a candidate decision-making policy that specifies one or more actions for the software application executed at the one or more remote computing devices to perform when decision-point events occur on the one or more remote devices, wherein the policy maps decision-point events of a same decision-point event type to different actions based on the time-series data in the sessions; determining and estimated average goal score for the candidate decision-making policy based on sessions that commenced during a time period to which the candidate decision-making policy corresponds; determining an estimated difference between the estimated average goal score and an average goal score for a control decision-making policy that was applied during the time period; determining a confidence level for the estimated difference based on a length of the time period; determining a price for the candidate decision-making policy based on the estimated difference and the confidence level; and rendering an indication of the estimated difference, the confidence level, and the price for display via the interface component.

The process 1100 may also include: rendering a button for the candidate decision-making policy via the interface component; detecting a click event on the button; and based on the detecting, deploying the candidate decision-making policy to a location in a network where decision-making requests originating from the software application are received.

The decision-making capabilities described herein may be implemented in synchronous or asynchronous manners. Synchronous and asynchronous integration of decision-making functions into a computing analytics framework may be selected based on the timing of when a decision is to be made and applied and the context that is needed and available at the time at which a decision is made. In a synchronous integration, a decision made in response to a decision-point event may block other activities from being performed until the decision is applied. In contrast, in an asynchronous integration, a decision may be made while other activity is being performed by a customer server, and the decision may be applied by executing a callback function based on instructions transmitted by the decision-making agent.

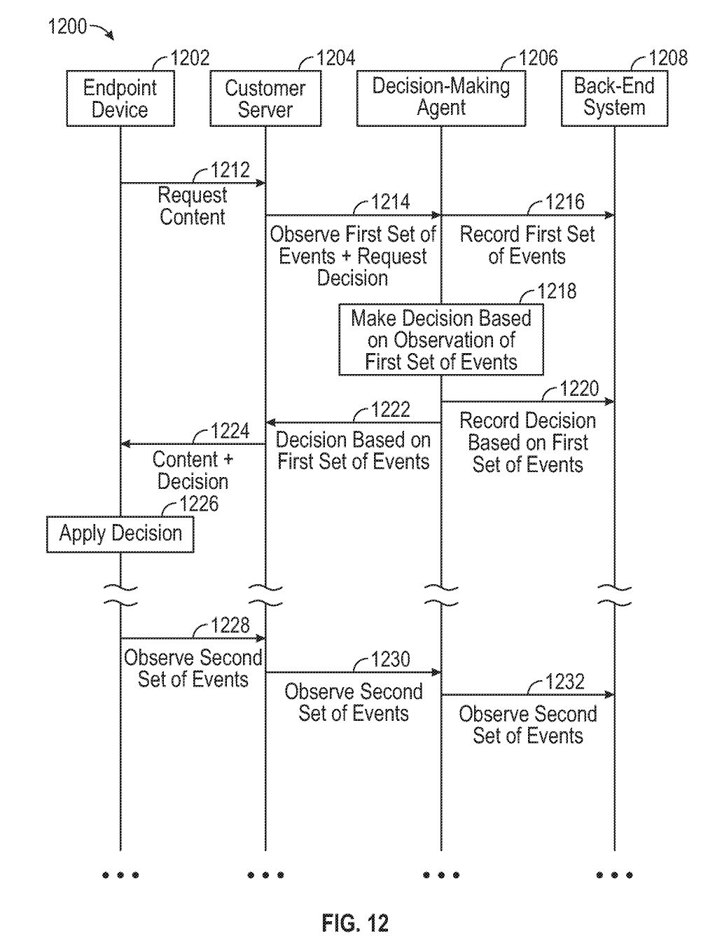

FIG. 12 is a message flow diagram illustrating a timeline 1200 of messages transmitted in a decision-making system in which synchronous decision-making functionality is integrated on a customer server, according to an embodiment. As illustrated, messages involved in performing synchronous decision-making on a customer server are exchanged between an endpoint device 1202, a customer server 1204 on which a software application and a thin client execute, a decision-making agent 1206, and a back-end system 1208.

As illustrated, timeline 1200 begins with endpoint device 1202 transmitting content request 1212 to customer server 1204 requesting content from the customer server. Customer server 1204 observes a first set of events and transmits the observation of the first set of events and a decision-making request 1214 to decision-making agent 1206, which in turn transmits a message 1216 to back-end system 1208 to record the occurrence of the first set of events in time-series data associated with a user of the software application (or requested content). As used herein, the first set of events included in message 1214 may be a single event or multiple events that may be used as context for a decision made by decision-making agent 1206. While observation and decision-making request 1214 is illustrated herein as a single message, it should be recognized that the observation of the first set of events and the decision-making request may be transmitted from customer server 1204 to decision-making agent 1206 as separate messages. These messages may, for example, be transmitted concurrently through different communications channels established between customer server 1204 and decision-making agent 1206 or sequentially (e.g., where the observation of the first set of events is transmitted to decision-making agent 1206 prior to transmission of the decision-making request). Transmission of observation and decision-making request 1214 as a single message may be used, for example, to avoid race conditions or other scenarios in which separate, non-concurrent transmission of the observation of the first set of events and the decision-making request may fail to initiate a decision-making request for the observed set of events (e.g., where a decision-making request from another endpoint device or for another set of observed events arrives and is executed prior to receipt of the decision-making request for the observed first set of events).

At block 1218, decision-making agent 1206 makes a decision using the first set of events (e.g., the events reported in observation 1214) as context for the decision. This decision may be made based on a limited set of context information available to the decision-making agent 1206 for the user of the software application (e.g., the first set of events reported in message 1214 and used as context for the decision requested through message 1214). After decision-making agent 1206 makes a decision, decision-making agent 1206 transmits a message 1220 to back-end system 1208 to record the decision made based on the observation of first event. The decision may be recorded in the time-series data associated with the user of the software application and may include information identifying the decision made (e.g., the one or more actions to be performed in response to an observation of the first event), timestamp data, and other information that may be used in making subsequent decisions. The decision made based on the first event is transmitted to customer server 1204 via message 1222, and customer server 1204 transmits the requested content and the made decision to endpoint device 1202 via message 1224. At 1226, the decision is applied at endpoint device 1202 to execute the one or more actions to be performed in response to the first observation.

Subsequently, other events may be observed at endpoint device 1202 and transmitted, via message 1228, to customer server 1204. Customer server 1204 passes the observed event or set of events to a decision-making agent 1206 via message 1230, and decision-making agent 1206 transmits the observed event or set of events to back-end system 1208 via message 1232 for recording in the time-series data associated with the user.

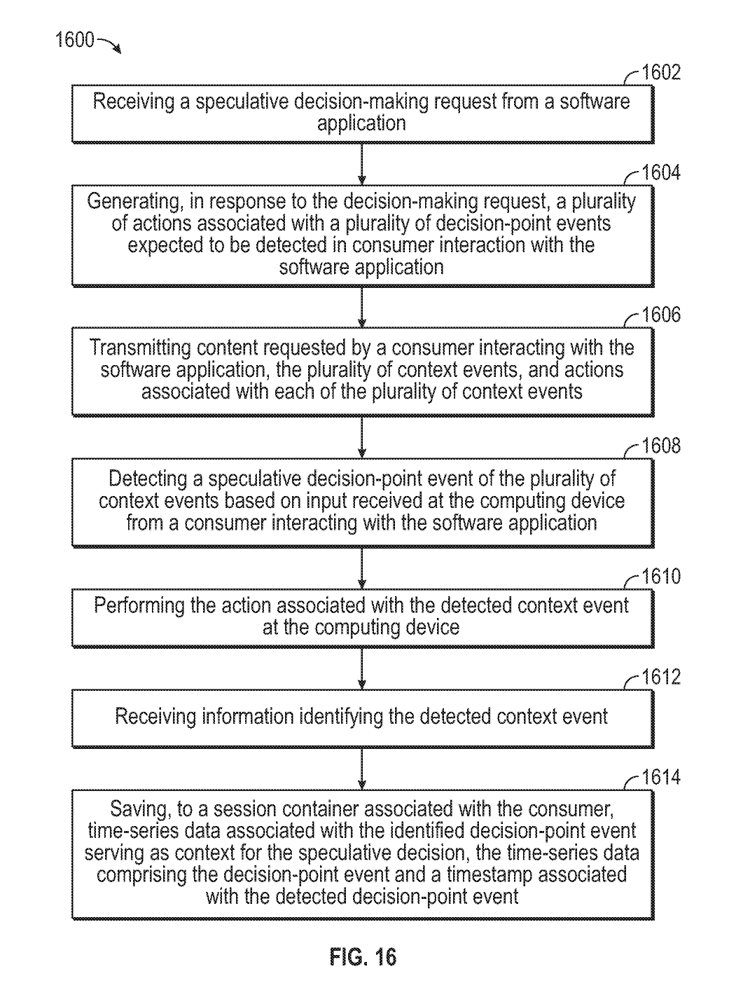

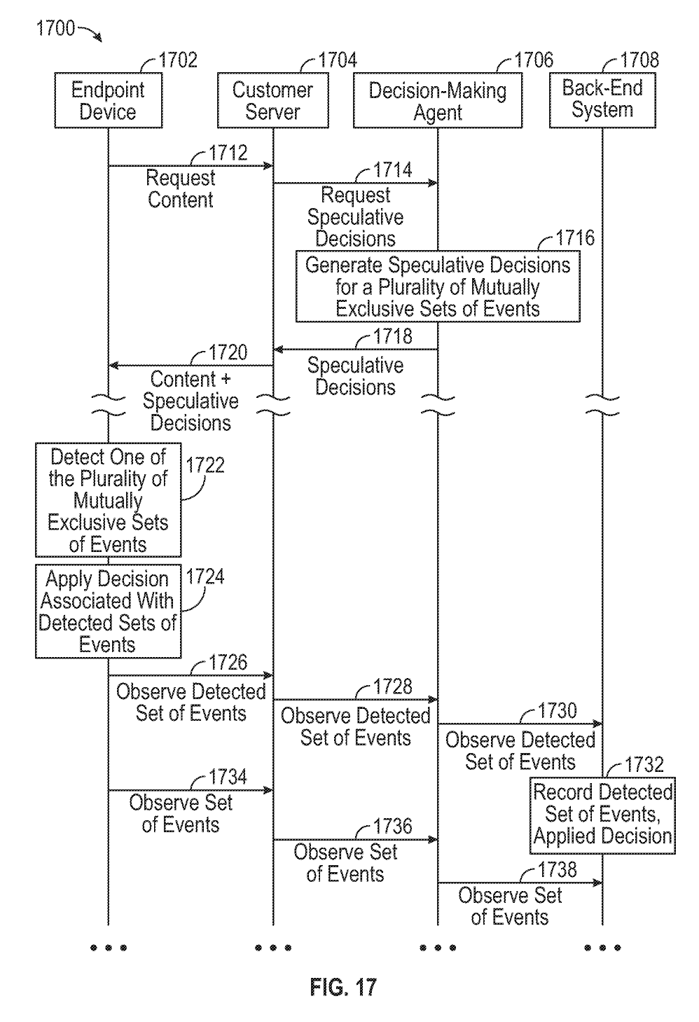

As discussed, the synchronous decision-making illustrated in FIG. 12 may be limited by the amount of contextual data available for use in making decisions in response to observations of events. For example, when a user begins interacting with a software application or a portion thereof, decision-making based on user session data may use a limited universe of contextual data (e.g., the context associated with an initial request for content from customer server 1204) to make a decision. To improve the decision-making process, speculative decision-making as described above with respect to FIGS. 16 and 17 and discussed below may be used to generate decisions for any number of events that might occur during execution of the software application.

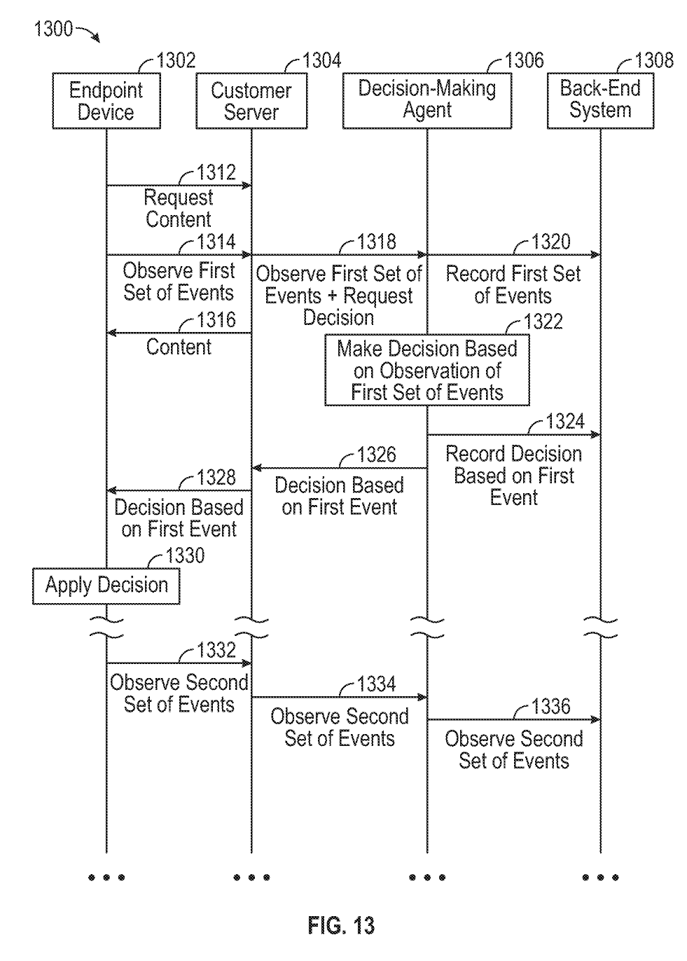

FIG. 13 is a message flow diagram illustrating a timeline 1300 of messages transmitted in a decision-making system in which asynchronous decision-making functionality is integrated on a customer server, according to an embodiment. Asynchronous decision-making, as discussed above, may be used when a decision need not be made and applied immediately in response to an observation of a decision-point event or initiation of a session of a software application. As illustrated, messages involved in performing asynchronous decision-making on a customer server are exchanged between an endpoint device 1302, a customer server 1304 on which a software application and a thin client execute, a decision-making agent 1306, and a back-end system 1308.

As discussed, in an asynchronous application, serving requested content to endpoint device 1302 and making and executing decisions based on observations of user interaction with a software application may be performed independently. The request to make a decision based on an observation of a decision-point event may not block other activity from occurring, and the decision generated for the observation of a decision-point event may be applied using a callback mechanism from the customer server 1304 to the endpoint device 1302.

Timeline 1300, as illustrated, begins with endpoint device 1302 transmitting a request 1312 for content from customer server 1304. Asynchronously, endpoint device 1302 also observes the occurrence of a first set of context events and transmits the observation of the first set of context events 1314 to customer server 1304. The first set of context events generally includes one or more events that may serve as context for a requested decision.

In response to request 1312 and observation 1314, customer server 1304 transmits the requested content to endpoint device 1302 via message 1316 and transmits the observation of the first set of context events and a decision-making request to decision-making agent 1306 via message 1318. While message 1318 is illustrated herein as a single message, it should be recognized that the observation of the first set of context events and the decision-making request may be transmitted from customer server 1304 to decision-making agent 1306 as separate messages, concurrently or sequentially. Transmission of the observation of the first set of context events and the decision-making request as a single message 1318 may be used, for example, to avoid race conditions or other scenarios in which separate, non-concurrent transmission of the observation of the first set of events and the decision-making request may fail to initiate a decision-making request for the observed set of events (e.g., where a decision-making request from another endpoint device or for another set of observed events arrives and is executed prior to receipt of the decision-making request for the observed first set of events).

Decision-making agent 1306 transmits the observation of the first event to back-end system 1308 via message 1320 instructing that back-end system 1308 record the first event in time-series data associated with the user of the software application. In response to a received decision-making request (which, as discussed above, may be transmitted as part of message 1318 or as a separate message from the message reporting an observation of the first set of context events), decision-making agent 1306, at block 1322, makes a decision based on the observation of the first set of context events. The decision is transmitted to customer server 1304 via message 1326, and customer server 1304 transmits the decision to endpoint device 1302 via message 1328 for application. At block 1330, the decision is applied.

Subsequently, other events (single or multiple) may be observed at endpoint device 1302 and transmitted, via message 1332, to customer server 1304. Customer server 1304 passes the observed event(s) to a decision-making agent 1306 via message 1334, and decision-making agent 1306 transmits the observed event(s) to back-end system 1308 via message 1336 for recording in the time-series data associated with the user. As discussed above, the decision-making agent 1306 may make a decision based on the observed event(s) upon receipt of a decision-making request from customer server 1304.

In some cases, decision-making functionality may be implemented using a thin client executing on an endpoint device. Thin clients may be deployed, for example, in web applications using locally executable code (e.g., web applications using asynchronous JavaScript and XML (AJAX) techniques to update content in the web applications) or mobile applications leveraging data accessible over public and/or private networks. Such an implementation may be selected for security and/or verification reasons. For example, the use of a thin client, which provides a wrapper that connects to a remote decision-making agent, may be selected for software verification reasons because the use of a thin client generally reduces an amount of code to be tested to ensure that integration of the decision-making agent with other application code does not adversely affect the functionality of the application code. In scenarios in which a thin client is used, the customer server may, however, be removed from the decision-making process, and thus, decision-making in these implementations may not be able to take into account data available on the customer servers when making decisions in response to observations of events on the endpoint device

In some cases, decision-making functionality may be implemented using monolithic clients. As discussed, a monolithic client allows for the integration of a decision-making agent with applications executing on a client device. By integrating the decision-making agent with applications executing on the client device, messages need not be exchanged between the applications executing on the client device and the decision-making agent through one or more intermediaries (e.g., through public networks). Thus, by using a monolithic client, intermediaries may be removed from the process of transmitting observations to and receiving decisions from a decision-making agent by making decisions locally.

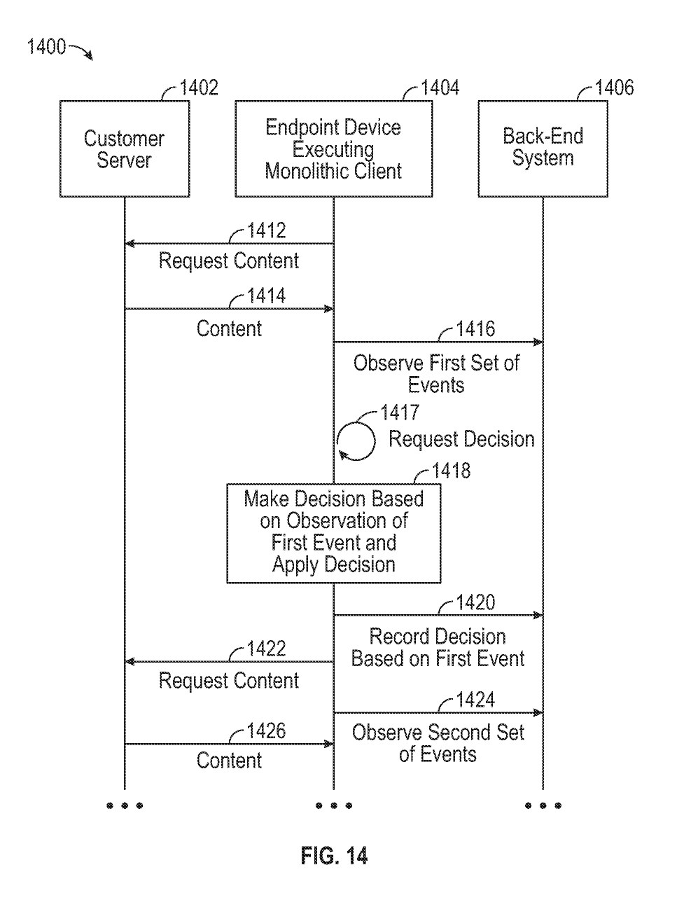

FIG. 14 is a message flow diagram illustrating a timeline 1400 of messages exchanged in performing synchronous decision-making using a monolithic client executing on an endpoint device, according to an embodiment. As illustrated, the messages involved in performing synchronous decision-making using a monolithic client may be exchanged between a customer server 1402, endpoint device executing the monolithic client 1404, and a back-end system 1406.

As illustrated, timeline 1400 begins with endpoint device 1404 transmitting a request for content 1412 to customer server 1402. Customer server 1402 responds to the request 1412 with the requested content 1414. Subsequently, after receiving the requested content 1414, endpoint device 1404 observes a first set of events, which may include one or more events forming the context upon which a decision may be made. The observation is transmitted by endpoint device 1404 to back-end system 1406 via message 1416 to be recorded in time-series data associated with a user of the software application. To request that a decision be made with respect to the observation of the first set of events, endpoint device 1404 executes a loopback request 1417 requesting a decision from the monolithic client. In response to decision-making request 1417, at block 1418, endpoint device 1404, using a monolithic client executing on the endpoint device, makes a decision based on the observation of the first event and applies the decision. In some embodiments, application of the decision may use resources previously downloaded onto endpoint device 1404 or otherwise included in the monolithic client; in other embodiments, application of the decision may include downloading resources from a remote source (e.g., customer server 1402) and executing the downloaded resources on endpoint device 1404. Subsequent to making the decision based on the observation of the first event, endpoint device 1404 transmits a message 1420 to record the decision based on the first event.

Subsequently, endpoint device 1404 can request additional content from customer server 1402 via message 1422, and customer server 1402 may satisfy the request by providing content 1424 to endpoint device 1404. As illustrated, a second set of events may be observed at endpoint device 1404 between transmitting content request 1422 to and receiving content 1424 from customer server 1402. Endpoint device 1404 can transmit the observation of the second event 1422 to back-end system 1406 to be stored in the time-series data for the user of the software application and may make and apply a decision in response to observing the second event (e.g., by executing a loopback request to request a decision from the monolithic client).

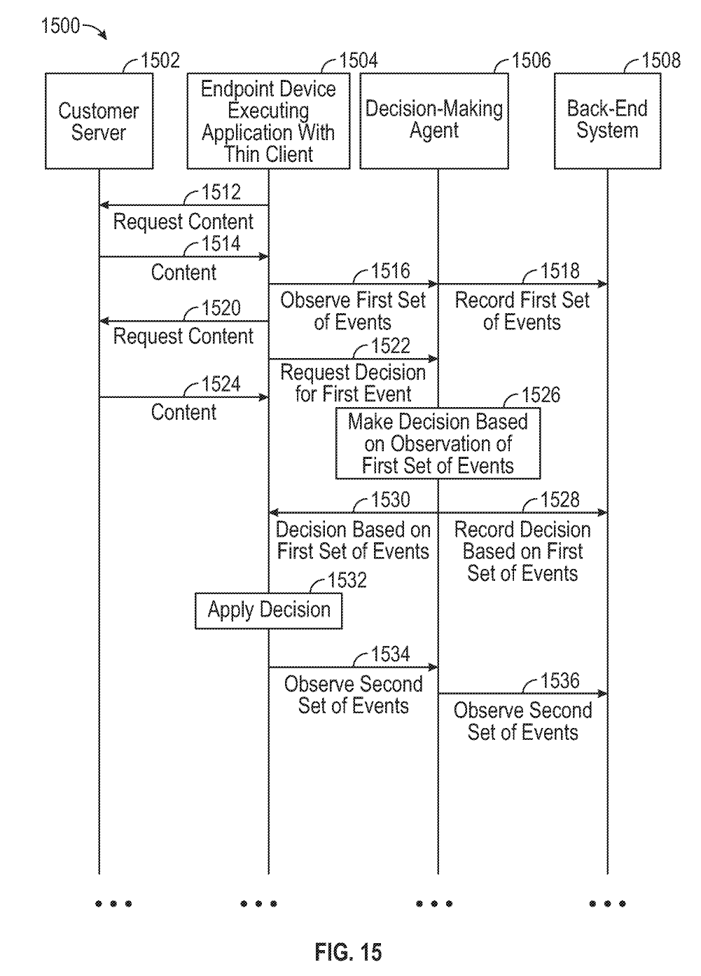

FIG. 15 is a message flow diagram illustrating a timeline 1500 of messages exchanged in performing asynchronous decision-making using a thin client executing on an endpoint device, according to an embodiment. As illustrated, messages involved in performing asynchronous decision-making using a thin client executing on an endpoint device may be exchanged between a customer server 1502, an endpoint device 1504, a decision-making agent 1506, and a back-end system 1508.

As illustrated, timeline 1500 begins with endpoint device 1504 transmitting, to customer server 1502, a request for content 1512. Customer server 1502 satisfies the request 1512 by transmitting a message 1514 including the requested content to the endpoint device.

Subsequently, endpoint device 1504 observes the occurrence of a first event and transmits the observation 1516 of the first event to decision-making agent 1506. Decision-making event transmits a message 1518 instructing back-end system 1508 to record the first event in time-series data associated with a user of the software application executing on endpoint device 1504. Decision-making agent 1506 receives, from endpoint device 1504, an explicit request for a decision to be made based on the observation of the first event. In response, decision-making agent 1506 makes a decision based on the observation of the first event at block 1526. Decision-making agent 1506 transmits the decision to back-end system 1508 with instructions to record the decision in time-series data associated with the user of the software application executing on endpoint device 1504. Decision-making agent 1506 additionally transmits, to the endpoint device 1504, a message 1530 informing the endpoint device of the decision made based on observing the first event. At block 1532, endpoint device 1504 applies the decision identified in message 1530. Subsequent observations of other events, illustrated by messages 1534 and 1536, may be processed similarly.

As illustrated, the request 1518 for a decision to be made based on the observation of the first event is performed asynchronously with a request 1520 for content from customer server 1502. The requested content 1524 may be received at endpoint device 1504 from customer server 1502, as illustrated, after endpoint device transmits request 1522 to decision-making agent 1506 and prior to receiving, from decision-making agent 1506, a decision to be applied at the endpoint device.

As discussed above, the examples illustrated in FIGS. 12-15 may make decisions based on some amount of contextual information. In some cases, such as when a user initiates a session of a software application or begins using a portion of a software application, no or limited amounts of contextual information may be present for a decision-making agent to make decisions to apply within the software application. In such a case, speculative decision-making techniques may be used to generate decisions for a variety of expected user actions, or contexts.

FIG. 16 illustrates a process 1600 for performing speculative decision-making in a decision-making system, according to one embodiment. Speculative decision-making may be used, for example, in scenarios in which different decisions may be applied in response to detecting different user contexts of a set of known user contexts that may be encountered during execution of a software application (e.g., at startup or initiation of a session of the software application or a portion thereof). The process 1600 can be implemented as a method or the process 1600 can be executed as instructions on a machine (e.g., by one or more processors), where the instructions are included on at least one non-transitory computer-readable storage medium.

Process 1600 begins at block 1602, where a decision-making system receives a speculative decision-making request from a software application. In some embodiments, the speculative decision-making request may be received from the software application when a session of the software application is initiated (e.g., when a user logs into the software application or otherwise begins interacting with the software application, when the software application creates a session container for the user, etc.); in other embodiments, the speculative decision-making request may be received during execution of the software application. The speculative decision-making request may, in some embodiments, include information identifying a plurality of context events for the speculative decisions that will be applied at some later point in time. Each of the plurality of context events may correspond to different actions that a user of the software application may be expected to perform in interacting with the software application.

At block 1604, the decision-making system generates, for each of the plurality of context events, one or more actions to be executed by the software application in response to detecting a specific one of the plurality of context events relative to the speculative decision applied at a later point in time. In some embodiments, each event of the plurality of events may include mutually exclusive context events. For example, where the occurrence or non-occurrence of an event can be represented as a Boolean value, the actions speculatively generated may be defined as a set of actions, where a first action in the set is executed where the context Boolean value resolves to Boolean TRUE, and a second, distinct, action in the set is executed where the context Boolean value resolves to Boolean FALSE. The one or more actions to be executed by the software application may be generated by comparing time-series data associated with the consumer identifier and an event type associated with context events for the one or more speculative decisions to a decision-making policy.

At block 1606, the decision-making system transmits content requested by a consumer interacting with the software application, the plurality of context events for the speculative decision to be made, and actions associated with each of the plurality of context events to the computing device on which the user interacts with the software application.

At block 1608, the decision-making system detects the occurrence of a specific speculative decision-point event having one of the plurality of context events for the speculative decision-making request. The occurrence of the specific event serving as context for the speculative decision-making request may be detected based on user input received at the computing device from a consumer interacting with the software application.

At block 1610, the action associated with the detected decision-point (context) event is executed at the computing device.

At block 1612, the decision-making system receives information, from the computing system, identifying the detected context event. Generally, receipt of information identifying the detected context event of the plurality of context events in a speculative decision may be considered a “releasing observation.” When a releasing observation occurs, the decision-making system may discontinue monitoring for the plurality of context events serving as context for the speculative decision. If one of the plurality of context events serving as context for the speculative decision is subsequently detected after the occurrence of the releasing observation, a decision may be generated for the subsequently detected decision-point event based on the context in which the subsequently detected decision-point event occurred, as discussed in further detail above.

At block 1614, the decision-making system saves, to a session container associated with the consumer, time-series data associated with the identified decision-point event serving as context for the speculative decision. The time-series data generally includes at least the detected event serving as context for the speculative decision, a timestamp associated with the event serving as context for the speculative decision, the action associated with the detected speculative decision-point event, and a timestamp associated with the action. The timestamps associated with the event serving as context for the speculative decision and the action associated with the detected speculative decision-point event may, in some embodiments, be set to a time prior to the time at which the event was actually detected at the computing device executing the software application and at which the action was performed. For example, the timestamp associated with the event serving as context for the speculative decision may be set to a time prior to the time at which the speculative decision-making request was received. The timestamp associated with the action performed in response to the detected event may be set to the time at which the speculative decision-making request was received. By setting timestamps associated with the decision-point event serving as context for the speculative decision and executed actions to a time prior to the actual occurrence of the decision-point event and execution of the corresponding action, a decision-making system can perform speculative decision-making for scenarios in which user activity is unknown but some set of user actions is expected to occur and properly identify the event serving as context for the speculative decision as context to the actions performed in response to the decision-point event. Additionally, other decisions may be made with respect to other decision-point events prior to the occurrence of one of the plurality of events serving as context for the speculative decision.

In some embodiments, the decision-making system may receive information about other decision-point events occurring in the software application distinct from the plurality of events serving as context for the speculative decision prior to receipt of a releasing observation (i.e., as discussed above, prior to receiving information indicating that one of the plurality of events serving as context for the speculative decision has occurred in the software application). In such a case, a decision is generated for the other events based on the context in which the other decision-point events were received (e.g., based on the time-series data associated with the consumer interacting with the software application). The decision-making system generally retains a mapping of the possible values for an event serving as context for a speculative decision with the action to be performed in response to detecting a particular event until the decision-making system receives a releasing observation (i.e., as discussed above, an indication that one of the plurality of context events occurred).

FIG. 17 is message flow diagram illustrating a timeline 1700 of messages exchanged in performing speculative decision-making, according to an embodiment. As illustrated, messages involved in performing speculative decision-making are exchanged between an endpoint device 1702, a customer server 1704 on which a software application and a thin client execute, a decision-making agent 1706, and a back-end system 1708.

As illustrated, timeline 1700 begins with endpoint device 1702 sending content request 1712 to customer server 1704 requesting content from the customer server. The content may include, for example, a portion of a web application a user wishes to interact with, textual content, multimedia content, and so on. In response to receiving content request 1712, customer server 1704 transmits a message 1714 requesting the generation of a plurality of speculative decisions to decision-making agent 1706. As discussed, in some embodiments, the request for the generation of speculative decisions may include information identifying a plurality of mutually exclusive sets of events that a user may be expected to perform. In response, at block 1716, decision-making agent 1706 generates speculative decisions for each of the mutually exclusive sets of events specified in message 1714. Decision-making agent 1706 transmits speculative decisions 1718 to customer server 1704, and customer server transmits a message 1720 including the content and speculative decisions to endpoint device 1702.

At a point in time subsequent to receiving message 1720 including the requested content and speculative decisions, an application executing on endpoint device 1702 detects, at block 1722, the occurrence of one of the plurality of mutually exclusive sets of events for which a speculative decision was requested. In response, at block 1724, the software application executing on endpoint device 1702 applies a decision associated with the detected set of events. As discussed, the decision may include performing one or more actions identified by decision-making agent 1706 as actions to perform when the user performs the detected set of events.

Endpoint device 1702 transmits an observation 1726 of the detected set of events to customer server 1704, which passes the observation to decision-making agent 1706 via message 1728. The decision-making agent 1706 transmits, via message 1730, the observed event to back-end system 1708. At block 1732, back-end system records the detected set of events and applied decision to a time-series data container associated with the consumer interacting with a software application via endpoint device 1702. As discussed, recording the detected set of events and applied decision generally includes backdating or timestamping records associated with the detected event and applied decision to a time period prior to the actual detection of the event and application of the decision associated with the detected set of events so that the detected set of events may be properly recognized and recorded as context for the applied decision. For example, the timestamp associated with the applied decision may be the timestamp associated with message 1714 in which customer server 1704 requested the generation of speculative decisions, and the timestamp associated with the detected set of events may be a timestamp prior to the timestamp associated with message 1714.

Subsequently, other events may be observed at endpoint device 1702 and transmitted, via message 1734, to customer server 1704. Customer server 1704 passes the observed event to a decision-making agent 1706 via message 1736, and decision-making agent 1706 transmits the observed event to back-end system 1708 via message 1738 for recording in the time-series data associated with the user and makes a decision in response to the observed event.

In some embodiments, information about events observed during execution of and user interaction with an application may be reported to a back-end system by the decision-making agent, the customer server, or the endpoint device on which an application is executing in what may be referred to as a hybrid integration. For example, context and decision events may be reported to the back-end system by the decision-making agent, and outcome events (e.g., events occurring after a decision is made from context events and the action associated with the decision is performed on an endpoint device or customer server) may be reported to the back-end system directly from an endpoint device or customer server. By reporting outcome events directly to the back-end system, latencies in reporting outcome events may be reduced, as messages including information about outcome events need not be transmitted to a decision-making agent for retransmission to the back-end system.

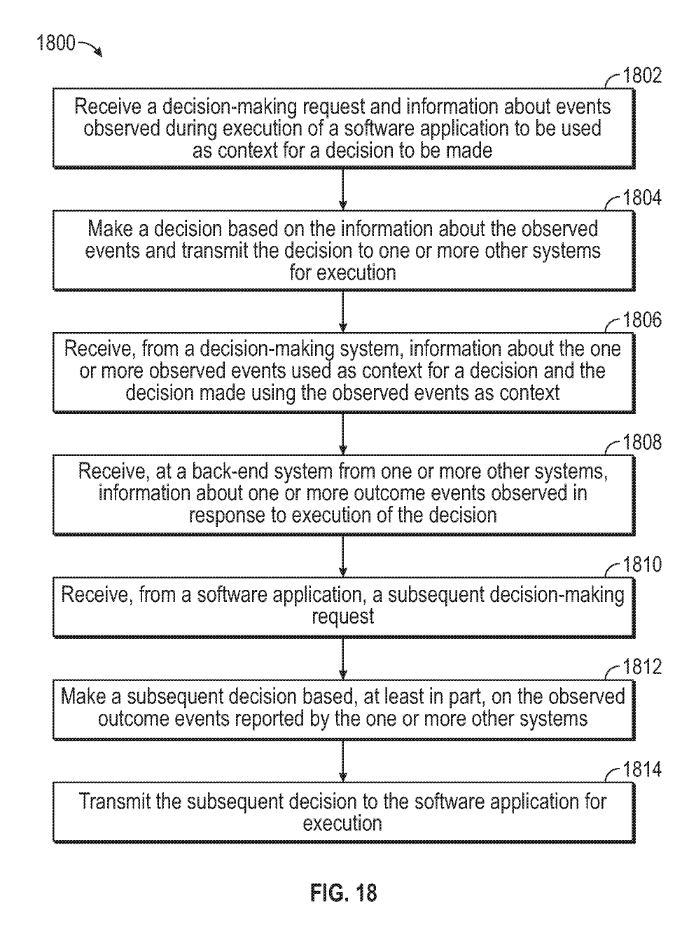

FIG. 18 illustrates a process 1800 for integrating decision-making functionality into an analytics framework, according to one embodiment. Process 1800 generally is illustrative of hybrid integrations of observation reporting where, as discussed above, context and decision events are reported to a back-end system by a first system and outcome events are reported to the back-end service by a second system. The process 1800 can be implemented as a method or the process 1800 can be executed as instructions on a machine (e.g., by one or more processors), where the instructions are included on at least one non-transitory computer-readable storage medium.

Process 1800 begins at block 1802, where a decision-making system receives information about events observed during execution of a software application to be used as context information for a decision to be made. In some embodiments, the received information may be received independently of a subsequently received decision-making request from the software application. As discussed above, the received information may also be received in conjunction with a decision-making request. As used herein, the observed events may be a single event or multiple events that may be used as context for a decision to be made by the decision-making system.

At block 1804, the decision-making system makes a decision based on the information about the observed events and transmits the decision to one or more other systems (e.g., a customer server or endpoint device) for execution. In some embodiments, making the decision may include generating a token containing information identifying the decision made, which may be used to link outcome events to the appropriate decision. The decision-making system may transmit information about the decision and the generated token to a customer server or endpoint device for execution.

At block 1806, the back-end system receives, from the decision-making system, the information about the one or more observed events and decisions made using the observed events as context. The back-end system can commit the observed context events and the decisions made based on the observed events to a data store for future use. In some embodiments, as discussed above, the observed context events and the decision made based on the observed decisions may be recorded in time-series data associated with a user of the software application (or requested content).

At block 1808, the back-end system receives, from the one or more other systems, information about outcome events observed in response to execution of the decision made from the observed context events. The information about outcome events observed in response to the decision made from the observed context events may be received directly from a customer server or an endpoint device. To link the observed outcome events reported directly from the one or more other systems, the information about the observed outcome events may be accompanied by the token received as part of the decision so that the observed events may be linked to the decision made from the context events previously reported to the decision-making system at block 1802. For example, the information about the observed outcome events may be received from a customer server in embodiments where synchronous or asynchronous decision-making functionality is integrated on a customer server, and the information about the observed outcome events may be received from an endpoint device where decision-making functionality is integrated in a monolithic client executing on an endpoint device, as discussed above.

At block 1810, the decision-making system receives subsequent decision-making request from the software application. The subsequent decision-making request may include information about one or more third events to be used as context for the requested subsequent decision. In some embodiments, the decision-making system can examine the observed outcome events in the time-series data to identify duplicate events in the observed outcome events and the events identified in the subsequent decision-making request. If duplicate events are identified in the observed outcome events and the events identified in the subsequent decision-making request, the duplicated events may be removed from one of the set of observed outcome events or the events identified in the subsequent decision-making request.

At block 1812, the decision-making system makes a subsequent decision using at least the observed outcome events as context for the requested subsequent decision. At block 1814, the subsequent decision is transmitted to the software application for execution.

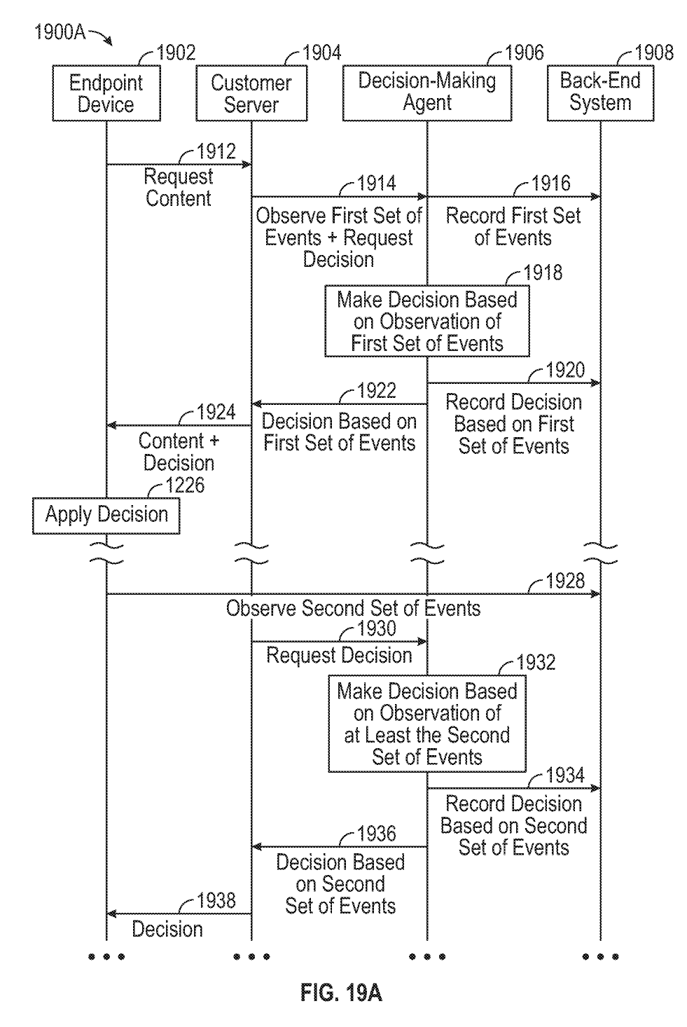

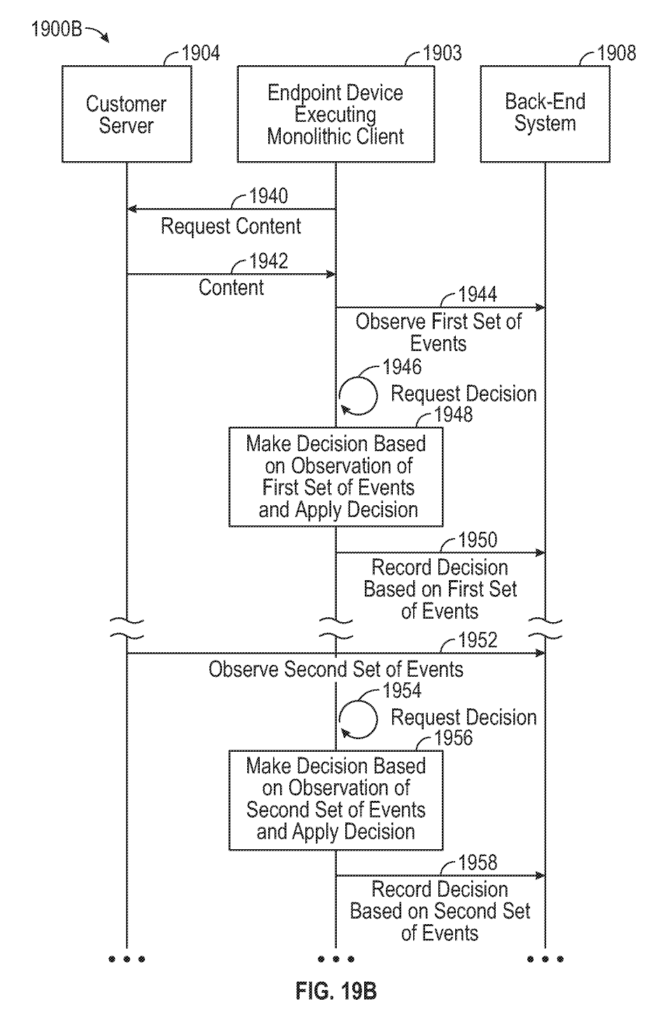

FIGS. 19A and 19B are example message flow diagrams illustrating hybrid integrations of observation reporting in a decision-making system, according to some embodiments.

FIG. 19A illustrates an example message flow diagram of a hybrid integration of observation reporting in a decision-making system in which observations are reported to a back-end system from an endpoint device. While FIG. 19A illustrates reporting of observations to a back-end system from an endpoint device, it should be recognized that these observations may additionally or alternatively be reported to a back-end system from a customer server.

As illustrated, timeline 1900A begins with endpoint device 1902 transmitting a content request 1912 to customer server 1904 to request specified content from the customer server. Customer server 1904 observes a first set of events and transmits the observation of the first set of events and a decision-making request 1914 to decision-making agent 1906. In turn, decision-making agent 1906 transmits a message 1916 to back-end system 1908 to record the occurrence of the first set of events in time-series data associated with a user of the software application (or the requested content). As used herein, the first set of events included in message 1914 may include a single event or multiple events to be used as context for a decision made by decision-making agent 1906. While observation and decision-making request 1914 is illustrated herein as a single message, it should be recognized that the observation of the first set of events and the decision-making request may be transmitted from customer server 1904 to decision-making agent 1906 as separate messages.

At block 1918, decision-making agent 1906 makes a decision using the first set of events (e.g., the events reported in message 1914) as context for the decision. After decision-making agent 1906 makes a decision at block 1918, decision-making agent 1906 transmits a message 1920 to back-end system 1908 to record the decision made based on the first set of events and a message 1922 to customer server 1904 informing the customer server of the decision made based on the first set of events. The decision may be recorded in the time-series data associated with the user of the software application and may include information identifying the decision made (e.g., the one or more actions to be performed in response to an observation of the first set of events), timestamp data, and other information that may be used in making subsequent decisions. Customer server 1904 may transmit the requested content and the decision made by decision-making agent 1906 to endpoint device 1902 via message 1924, and at block 1926, endpoint device 1902 may apply the decision made by decision-making agent 1906.

Subsequently, endpoint device 1902 or customer server 1904 may report observations of a second set of events directly to back-end system 1908 via message 1928. The observed second set of events generally includes events that may be considered outcome events observed in response to application of the decision at block 1926. As illustrated, message 1928 represents transmission of observations of the second set of events (e.g., outcome events relative to the applied decision) from endpoint device 1902; however, it should be recognized that message 1928 may be transmitted from customer server 1904 rather than endpoint device 1902.

At a later point in time, customer server 1904 requests a decision by transmitting a request 1930 to decision-making agent 1906. Decision-making agent may make a decision based on the observation of at least the second set of events which, as discussed above, is recorded by back-end system 1908 in time-series data associated with a user identifier, the requested content, or other time-series information based on which decisions may be made and may be linked to the decision recorded via message 1920 through a token or other identifier identifying the decision. After making a decision at block 1932, decision-making agent 1906 transmits message 1934 to record the decision made based on the second set of events at back-end system 1908 and transmits message 1936 informing customer server 1904 of the decision made based on the second set of events. At block 1938, the decision made based on the second set of events is transmitted from customer server 1904 to endpoint device 1902 for execution. In some embodiments, request 1930 may be transmitted in response to a request for content received by customer server 1904 from endpoint device 1902, and decision 1938 may be transmitted from customer server 1904 to endpoint device 1902 with content requested by a user of endpoint device 1902.

FIG. 19B illustrates an example message flow diagram of a hybrid integration of observation reporting in a decision-making system in which observations are reported to a back-end system from a customer server in a deployment where an endpoint device executes a monolithic client including decision-making functionality.

As illustrated, timeline 1900B begins with endpoint device 1903 transmitting a content request 1940 to customer server 1904 to request specified content from the customer server. Customer server 1904 provides the requested content to the endpoint device 1903 via message 1942, and endpoint device 1903 may subsequently observe a first set of events and transmit the observation of the first set of events to back-end system 1908 for recordation. As used herein, the first set of events included in message 1944 may include a single event or multiple events to be used as context for a decision made by a monolithic client executing on endpoint device 1903.

Subsequently, endpoint device 1903 executes a loopback request 1946 requesting a decision from the monolithic client. In response to decision-making request 1946, at block 1948, endpoint device 1903, using a monolithic client executing on the endpoint device, makes a decision based on the observation of the first event and applies the decision. In some embodiments, application of the decision may use resources previously downloaded onto endpoint device 1903 or otherwise included in the monolithic client; in other embodiments, application of the decision may include downloading resources from a remote source (e.g., customer server 1904) and executing the downloaded resources on endpoint device 1903. Subsequent to making the decision based on the observation of the first event, endpoint device 1903 transmits a message 1950 to record the decision based on the first event.

Subsequently, customer server 1904 may report observations of a second set of events directly to back-end system 1908 via message 1952. As discussed above, the observed set of events generally includes events that may be considered observed outcome events observed in response to application of the decision at block 1948. In some embodiments, to facilitate linking the observed outcome decisions reported in message 1952 with the decision applied at block 1948, message 1952 may include an identifier associated with the decision made from an observation of the first set of events (e.g., a token generated as part of the decision-making process at block 1948).

At a later point in time, endpoint device 1903 executes a loopback request 1954 to request a decision to be made based on the observation of at least the second set of events which, as discussed above, is recorded by back-end system 1908 in time-series data associated with a user identifier, the requested content, or other time-series information based on which decisions may be made. At block 1956, a monolithic client executing on endpoint device 1903 may make a decision based on the observed second set of events 1952 recorded at back-end system 1908 and linked to the decision made at block 1948, and the monolithic client may apply the decision made. The monolithic client executing on endpoint device 1903 may also transmit message 1958 to back-end system 1908 to record the decision made at block 1948.

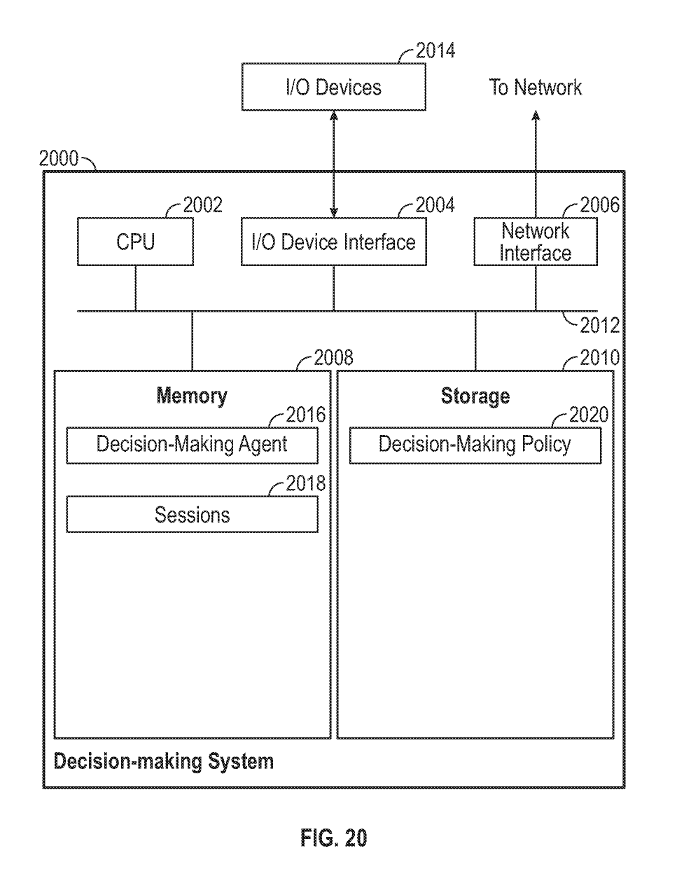

FIG. 20 illustrates a decision-making system 2000, according to an embodiment. As shown, the decision-making system 2000 includes a central processing unit (CPU) system 2002, at least one I/O device interface 2004 which may allow for the connection of various I/O devices 2014 (e.g., keyboards, displays, mouse devices, pen input, speakers, microphones, motion sensors, etc.) to the decision-making system 2000, network interface 2006, a memory 2008, storage 2010, and an interconnect 2012.

CPU 2002 may retrieve and execute programming instructions stored in the memory 2008. Similarly, the CPU 2002 may retrieve and store application data residing in the memory 2008. The interconnect 2012 transmits programming instructions and application data, among the CPU 2002, I/O device interface 2004, network interface 2006, memory 2008, and storage 2010. CPU 2002 can represent a single CPU, multiple CPUs, a single CPU having multiple processing cores, and the like. Additionally, the memory 2008 represents random access memory. Furthermore, the storage 2010 may be a disk drive, solid state drive, or a combination thereof. Although shown as a single unit, the storage 2010 may be a combination of fixed or removable storage devices, such as fixed disc drives, removable memory cards or optical storage, network attached storage (NAS), or a storage area-network (SAN).

As shown, memory 2008 includes a decision-making agent 2016 and sessions 2018. Storage 2010 includes a decision-making policy 2020.

The decision-making system 2000 can operate in the following manner. When a decision-point event is detected in a software application running at a user device, the software application sends a decision-making request to the decision-making agent 2016. The request includes a consumer ID. The decision-making agent 2016 retrieves time-series data associated with the consumer ID from the sessions 2018 and compares the time-series data and a type of the decision-point event to the decision-making policy 2020. Based on the comparison, the decision-making agent 2016 selects one or more actions for the user device to perform in response to the decision-making request. The decision-making agent 2016 sends an indication of the selected actions in response to the decision-making request.

Note, descriptions of embodiments of the present disclosure are presented above for purposes of illustration, but embodiments of the present disclosure are not intended to be limited to any of the disclosed embodiments. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program.

In the preceding, reference is made to machine-learning models. There are many different types of inductive and transductive machine-learning models that can be used in embodiments disclosed herein. Examples include adsorption models, neural networks, support vector machines, Bayesian belief networks, association-rule models, decision trees, nearest-neighbor models (e.g., k-NN), regression models, artificial neural networks, deep belief networks, and Q-learning models, among others.

Many configurations and parameter combinations may be possible for a given type of machine-learning model. For example, with a neural network, the number of hidden layers, the number of hidden nodes in each layer, and the existence of recurrence relationships between layers can vary. Batch gradient descent or stochastic gradient descent may be used in the process of tuning weights for the nodes in the neural network. The learning rate parameter for a neural network, which partially determines how much each weight may be adjusted at each step, may be varied. Input features may be normalized. Other parameters that are known in the art, such as momentum, may also be applied to improve neural network performance.

In the preceding, reference is made to Internet-of-Things (IoT). Devices such as door sensors for security systems, gaming consoles, electronic safes, global positioning systems (GPSs), location trackers, activity trackers, laptop computers, tablet computers, automated door locks, air conditioners, furnaces, heaters, dryers, wireless sensors in wireless sensor networks, large or small appliances, personal alert devices (e.g., used by elderly persons who have fallen in their homes), pacemakers, bar-code readers, implanted devices, ankle bracelets (e.g., for individuals under house arrest), prosthetic devices, telemeters, traffic lights, user equipments (UEs), or any apparatuses including digital circuitry that is able to achieve network connectivity may be considered IoT devices or networking devices for the purposes of this disclosure.

Furthermore, individual machine learning models can be combined to form an ensemble machine-learning model. An ensemble machine-learning model may be homogenous (i.e., using multiple member models of the same type) or non-homogenous (i.e., using multiple member models of different types). Individual machine-learning models within an ensemble may all be trained using the same training data or may be trained using overlapping or non-overlapping subsets randomly selected from a larger set of training data. The Random-Forest model, for example, is an ensemble model in which multiple decision trees are generated using randomized subsets of input features and/or randomized subsets of training instances.

While the foregoing is directed to embodiments of the present disclosure, other and further embodiments of the disclosure may be devised without departing from the basic scope thereof, and the scope thereof is determined by the claims that follow.

What is claimed is:

1. A method for integrating active decision-making functionality into a computing analytics framework, comprising:
generating a decision-making policy representing logic learned by a machine-learning model during training based on time-series data collected for a plurality of sessions of a remotely-executed software application;
deploying the decision-making policy to a location in the computing network where decision-making requests originating from the software application are received;
receiving a decision-making request originating from the software application, wherein the decision-making request includes a consumer identifier and indicates a decision-point event type, wherein the decision-point event type represents mapping between a type of event triggering a decision-point event and an action, the mapping being based on time-series data associated with consumers that interact with a software application;
retrieving, from a data repository, time-series data in a session associated with the consumer identifier;
selecting one or more of the different actions for the software application to perform by comparing the time-series data and the event type to the decision-making policy;
sending an indication of the one or more selected actions in response to the decision-making request; and
updating the time-series data in the session associated with the consumer identifier in the data repository to reflect the decision-point event and the one or more selected actions.

2. The method of claim 1, wherein generating the decision-making policy comprises:
receiving the time-series data from a remote source associated with the software application, wherein the time-series data comprises session data associated with a respective consumer;
storing the time-series data in a persistent data repository;
receiving a goal definition specifying how to calculate a goal score based on at least one metric that is calculable based on the time-series data;
for each of the sessions, determining a corresponding value for the at least one metric for the session;
based on the time-series data and the values for the sessions, training a machine-learning model to determine, based on events that precede a decision-point event in a session, one or more actions for the remotely executed software application to perform in response to the decision-point event to increase a probability that a goal score for the session will satisfy a hazard condition.

3. The method of claim 1, wherein deploying the policy to a location in the computing network where decision-making requests originating from the software application are received comprises:
sending the policy to a decision-making agent executing on a publicly-accessible server receiving decision-making requests from a plurality of software applications.

4. The method of claim 1, wherein the time-series data in the session includes timestamps and event descriptions for events that occurred on a plurality of devices through which a consumer specified by the consumer identifier has previously accessed the software application.

5. The method of claim 1, further comprising:
adding the updated time-series data to the data repository;
updating the decision-making policy based, at least in part, on the updated time-series data; and
replacing the decision-making policy with the updated decision-making policy.

6. The method of claim 1, wherein the decision-making request includes a number indicating how many actions to select, and wherein selecting one or more of the different actions for the software application to perform and sending an indication of the one or more selected actions comprises:
generating an ordered list of a subset of the different actions, wherein a cardinality of the subset matches the number.

7. The method of claim 1, wherein generating the decision-making policy is performed on a first computing system and wherein the decision-making policy is deployed on a second computing system in a network.

8. The method of claim 1, wherein the data repository is contained in Random Access Memory (RAM) memory, a cache, or a combination of the RAM and the cache local to a computing system on which the decision-making policy is deployed.

9. The method of claim 1, further comprising:
grouping a plurality of sessions, including the session associated with the consumer identifier, into bins, wherein each bin corresponds to a time interval and includes sessions that have starting times within the time interval;
for each session:
calculating a current value of the first metric for the session using the time-series data included in the session, wherein at least a portion of the time-series data used to calculate the current value of the first metric describes events that occurred outside of a time interval corresponding to a bin into which the session is grouped, and
determining a current goal score for the session based on the current value for the first metric and the goal definition;
for each bin, calculating a current average goal score for the bin based on the current values goal scores for the sessions that are grouped into the bin; and
rendering a graphical plot of the current average goal scores for the bins against time as partitioned by the bins for display.

10. The method of claim 9, wherein each of the sessions includes at least one decision-point event of a selected type, and wherein the method further comprises:
receiving, from a policy generator, a candidate decision-making policy that specifies one or more actions for the software application executed at the one or more remote computing devices to perform when decision-point events occur on the one or more remote devices, wherein the policy maps decision-point events of a same decision-point event type to different actions based on the time-series data in the sessions;
determining and estimated average goal score for the candidate decision-making policy based on sessions that commenced during a time period to which the candidate decision-making policy corresponds;
determining an estimated difference between the estimated average goal score and an average goal score for a control decision-making policy that was applied during the time period;
determining a confidence level for the estimated difference based on a length of the time period;
determining a price for the candidate decision-making policy based on the estimated difference and the confidence level; and
rendering an indication of the estimated difference, the confidence level, and the price for display.

11. A system for integrating active decision-making functionality into a computing analytics framework, comprising:
a processor configured to:
generate a decision-making policy representing logic learned by a machine-learning model during training based on time-series data collected for a plurality of sessions of a remotely-executed software application,
deploy the decision-making policy to a location in the computing network where decision-making requests originating from the software application are received,
receive a decision-making request originating from the software application, wherein the decision-making request includes a consumer identifier and indicates a decision-point event type, wherein the decision-point event type represents mapping between a type of event triggering a decision-point event and an action, the mapping being based on time-series data associated with consumers that interact with a software application,
retrieve, from a data repository, time-series data in a session associated with the consumer identifier,
select one or more of the different actions for the software application to perform by comparing the time-series data and the event type to the decision-making policy,
send an indication of the one or more selected actions in response to the decision-making request, and
update the time-series data in the session associated with the consumer identifier in the data repository to reflect the decision-point event and the one or more selected actions; and
a memory.

12. The system of claim 11, wherein the processor is configured to generate the decision-making policy by:
receiving the time-series data from a remote source associated with the software application, wherein the time-series data comprises session data associated with a respective consumer;
storing the time-series data in a persistent data repository;
receiving a goal definition specifying how to calculate a goal score based on at least one metric that is calculable based on the time-series data;
for each of the sessions, determining a corresponding value for the at least one metric for the session;
based on the time-series data and the values for the sessions, training a machine-learning model to determine, based on events that precede a decision-point event in a session, one or more actions for the remotely executed software application to perform in response to the decision-point event to increase a probability that a goal score for the session will satisfy a hazard condition.

13. The system of claim 11, wherein the time-series data in the session includes timestamps and event descriptions for events that occurred on a plurality of devices through which a consumer specified by the consumer identifier has previously accessed the software application.

14. The system of claim 11, wherein the processor is further configured to:
add the updated time-series data to the data repository;
update the decision-making policy based, at least in part, on the updated time-series data; and
replace the decision-making policy with the updated decision-making policy.

15. The system of claim 11, wherein the decision-making request includes a number indicating how many actions to select, and wherein the processor is configured to select one or more of the different actions for the software application to perform and send an indication of the one or more selected actions by:
generating an ordered list of a subset of the different actions, wherein a cardinality of the subset matches the number.

16. The system of claim 11, wherein the processor is configured to generate the decision-making policy is performed on a first computing system and wherein the decision-making policy is deployed on a second computing system in a network.

17. The system of claim 11, wherein the data repository is contained in Random Access Memory (RAM) memory, a cache, or a combination of the RAM and the cache local to a computing system on which the decision-making policy is deployed.

18. The system of claim 11, wherein the processor is further configured to:
group a plurality of sessions, including the session associated with the consumer identifier, into bins, wherein each bin corresponds to a time interval and includes sessions that have starting times within the time interval;
for each session:
calculate a current value of the first metric for the session using the time-series data included in the session, wherein at least a portion of the time-series data used to calculate the current value of the first metric describes events that occurred outside of a time interval corresponding to a bin into which the session is grouped, and
determine a current goal score for the session based on the current value for the first metric and the goal definition;
for each bin, calculate a current average goal score for the bin based on the current values goal scores for the sessions that are grouped into the bin; and
render a graphical plot of the current average goal scores for the bins against time as partitioned by the bins for display.

19. The system of claim 98, wherein each of the sessions includes at least one decision-point event of a selected type, and wherein the processor is further configured to:
receive, from a policy generator, a candidate decision-making policy that specifies one or more actions for the software application executed at the one or more remote computing devices to perform when decision-point events occur on the one or more remote devices, wherein the policy maps decision-point events of a same decision-point event type to different actions based on the time-series data in the sessions;
determine and estimated average goal score for the candidate decision-making policy based on sessions that commenced during a time period to which the candidate decision-making policy corresponds;
determine an estimated difference between the estimated average goal score and an average goal score for a control decision-making policy that was applied during the time period;
determine a confidence level for the estimated difference based on a length of the time period;
determine a price for the candidate decision-making policy based on the estimated difference and the confidence level; and
render an indication of the estimated difference, the confidence level, and the price for display.

20. A system for integrating active decision-making functionality into a computing analytics framework, comprising:
a policy generation engine configured to:
generate a decision-making policy representing logic learned by a machine-learning model during training based on time-series data collected for a plurality of sessions of a remotely-executed software application, and
deploy the decision-making policy to a location in the computing network where decision-making requests originating from the software application are received; and
a decision-making agent configured to:
receive a decision-making request originating from the software application, wherein the decision-making request includes a consumer identifier and indicates a decision-point event type, wherein the decision-point event type represents mapping between a type of event triggering a decision-point event and an action, the mapping being based on time-series data associated with consumers that interact with a software application,
retrieve, from a data repository, time-series data in a session associated with the consumer identifier,
select one or more of the different actions for the software application to perform by comparing the time-series data and the event type to the decision-making policy,
send an indication of the one or more selected actions in response to the decision-making request, and
update the time-series data in the session associated with the consumer identifier in the data repository to reflect the decision-point event and the one or more selected actions.
